(19) United States
(12) Patent Application Publication
(10) Pub. No.: US 2025/0296802 A1
(43) Pub. Date: Sep. 25, 2025

(54) MEDIUM PROCESSING APPARATUS AND IMAGE FORMING SYSTEM INCORPORATING SAME

(71) Applicants: Nobuyoshi Suzuki, KANAGAWA (JP); Kei Sasaki, KANAGAWA (JP); Keisuke Sugiyama, KANAGAWA (JP); Kazuki Seto, KANAGAWA (JP); Sachika Tamaki, KANAGAWA (JP); Shohei Saito, KANAGAWA (JP); Kohta Abe, KANAGAWA (JP); Takashi Yamamoto, KANAGAWA (JP); Mitsuhiro Sugawara, KANAGAWA (JP)

(72) Inventors: Nobuyoshi Suzuki, KANAGAWA (JP); Kei Sasaki, KANAGAWA (JP); Keisuke Sugiyama, KANAGAWA (JP); Kazuki Seto, KANAGAWA (JP); Sachika Tamaki, KANAGAWA (JP); Shohei Saito, KANAGAWA (JP); Kohta Abe, KANAGAWA (JP); Takashi Yamamoto, KANAGAWA (JP); Mitsuhiro Sugawara, KANAGAWA (JP)

(73) Assignee: Ricoh Company, Ltd., Tokyo (JP)

(21) Appl. No.: 19/081,339

(22) Filed: Mar. 17, 2025

(30) Foreign Application Priority Data
Mar. 21, 2024 (JP) 2024-045543

(51) Int. Cl. B65H 37/04; B41J 3/44; B41J 11/00; B65H 43/08; G03G 15/00

(52) U.S. Cl. CPC B65H 37/04; B65H 43/08; B41J 3/44; B41J 11/0095; B65H 2301/5161; B65H 2301/5162; B65H 2553/41; B65H 2801/27; G03G 15/6544; G03G 2215/00738; G03G 2215/00742

(57) ABSTRACT

A medium processing apparatus includes a liquid applier, a medium pressing unit, a detector, and circuitry. The liquid applier includes a liquid application member to contact a part of a medium and apply liquid to the part of the medium. The medium pressing unit presses the medium to which the liquid is applied, and moves the liquid application member relative to the medium. The detector detects a relative position between the medium pressing unit and the liquid application member. The circuitry is to determine a movement amount of the liquid application member relative to the medium based on the relative position detected by the detector, and move the liquid application member relative to the medium based on the movement amount.

### CROSS-REFERENCE TO RELATED APPLICATION

This patent application is based on and claims priority pursuant to 35 U.S.C. § 119(a) to Japanese Patent Application No. 2024-045543, filed on Mar. 21, 2024, in the Japan Patent Office, the entire disclosure of which is hereby incorporated by reference herein.

### BACKGROUND

### Technical Field

Embodiments of the present disclosure relate to a medium processing apparatus and an image forming system.

### Related Art

Various types of medium processing apparatuses are known that bind a sheet bundle of stacked sheet media. Such medium processing apparatuses employ binding processes including, for example, a “stapling process” for penetrating needle-shaped members (binding members) through a sheet bundle to bind the sheet bundle and a “crimp binding process” for applying pressure to and deform a part of a sheet bundle to bind the sheet bundle.

There is also known a liquid applying crimp binding apparatus that applies liquid to a sheet as a sheet-like medium when performing crimp binding. The liquid applying crimp binding apparatus applies liquid by directly pressing a liquid application member which is a foam material against a medium.

Regarding a liquid applying crimp binding apparatus, a configuration is disclosed in which, regarding pressing control when liquid is applied, an amount of applied liquid is adjusted according to a collapsing amount of a liquid application member to be pressed, and liquid applying crimp binding can be executed under an optimum liquid applying condition.

In the technique disclosed in a liquid application and crimp binding apparatus in the art, device adjustment is performed on the basis of a loading surface position of a loading table on which a medium to apply liquid is loaded of 0 mm, a thickness of a medium bundle to apply liquid is calculated from the number of media and thickness information of the medium to determine a liquid applying surface position, and a collapsing amount of a liquid application member is adjusted.

### SUMMARY

Embodiments of the present disclosure described herein provide a novel medium processing apparatus including a liquid applier, a medium pressing unit, a detector, and circuitry. The liquid applier includes a liquid application member to contact a part of a medium and apply liquid to the part of the medium. The medium pressing unit presses the medium to which the liquid is applied, and moves the liquid application member relative to the medium. The detector detects a relative position between the medium pressing unit and the liquid application member. The circuitry is to determine a movement amount of the liquid application member relative to the medium based on the relative position detected by the detector, and move the liquid application member relative to the medium based on the movement amount.

Further, embodiments of the present disclosure described herein provide an image forming system including an image forming apparatus to form an image on each medium of multiple media, and a medium processing apparatus to perform liquid application on at least one medium of the multiple media including each medium on which the image has been formed by the image forming apparatus. The medium processing apparatus includes a liquid applier, a medium pressing unit, and a detector. The liquid applier includes a liquid application member to contact a part of a medium and apply liquid to the part of the medium. The medium pressing unit presses the medium to which the liquid is applied, and moves the liquid application member relative to the medium. The detector detects a relative position between the medium pressing unit and the liquid application member. The image forming apparatus includes circuitry to determine a movement amount of the liquid application member relative to the medium based on the relative position detected by the detector, and move the liquid application member relative to the medium based on the movement amount.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view illustrating a general arrangement of an image forming system;

FIG. 2 is a view illustrating an internal configuration of a post-processing apparatus according to a first embodiment;

FIG. 3 is a schematic view of an edge binder as viewed from an upstream side in a conveyance direction;

FIG. 4 is a schematic view of the edge binder as viewed from a liquid applier side in a main scanning direction;

FIGS. 5A and 5B are schematic views illustrating a configuration of a crimper of the edge binder;

FIG. 6 is a schematic view of a staple binder as viewed from the upstream side in the conveyance direction;

FIG. 7 is a schematic view of a modification of the staple binder as viewed from the upstream side in the conveyance direction;

FIGS. 8A and 8B are views each illustrating the location and configuration of a second liquid storage tank in the post-processing apparatus;

FIG. 9 including FIGS. 9(A), 9(B), and 9(C) is a diagram illustrating a configuration of attachment and detachment of the second liquid storage tank of the post-processing apparatus;

FIG. 10 is a hardware configuration diagram of a control block to control the post-processing apparatus according to the first embodiment;

FIG. 11 is a flowchart of a binding process performed by an edge binder;

FIGS. 12A, 12B, 12C, and 12D are diagrams illustrating positions of the edge binder during an operation of one-point binding;

FIGS. 13A, 13B, 13C, 13D, 13E, 13F, 13G, and 13H are diagrams illustrating positions of the edge binder during an operation of two-point binding;

FIG. 14 is a diagram describing details of a liquid applying and moving assembly according to the present embodiment;

FIG. 15 is a diagram describing an operation and a state of the liquid applying and moving assembly;

FIG. 16 is a diagram describing an operation and a state of the liquid applying and moving assembly;

FIG. 17 is a diagram illustrating a category of a control value of a liquid application member;

FIG. 18 is a flowchart describing an initial setting process of the liquid applying and moving assembly;

FIG. 19 is a flowchart of a liquid application process including operation control of the liquid applying and moving assembly;

FIG. 20 is a flowchart of binding processing;

FIG. 21 is a diagram illustrating an internal configuration of a post-processing apparatus according to a second embodiment;

FIGS. 22A, 22B, and 22C are diagrams of an internal tray according to the second embodiment in a thickness direction of a sheet;

FIG. 23 is a schematic view illustrating a crimper according to the second embodiment, viewed from a downstream side in a conveyance direction of the sheet;

FIGS. 24A and 24B are schematic views of a liquid applier according to the second embodiment, viewed from the thickness direction of the sheet;

FIGS. 25A, 25B, and 25C are cross-sectional views taken along XXV-XXV of FIG. 24A;

FIGS. 26A, 26B, and 26C are cross-sectional views taken along XXVI-XXVI of FIG. 24A;

FIG. 27 is a hardware configuration diagram of a control block of the post-processing apparatus according to the second embodiment;

FIG. 28 is a flowchart of post-processing of the post-processing apparatus according to the second embodiment;

FIG. 29 is a diagram illustrating an overall configuration of a modification of the image forming system;

FIGS. 30A and 30B are diagrams illustrating Modification 1 of a controller of the post-processing apparatus; and

FIGS. 31A and 31B are diagrams illustrating Modification 2 of a controller of the post-processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Embodiment of Image Forming System

A description is given of an image forming system 1 according to an embodiment of the present disclosure, with reference to the drawings.

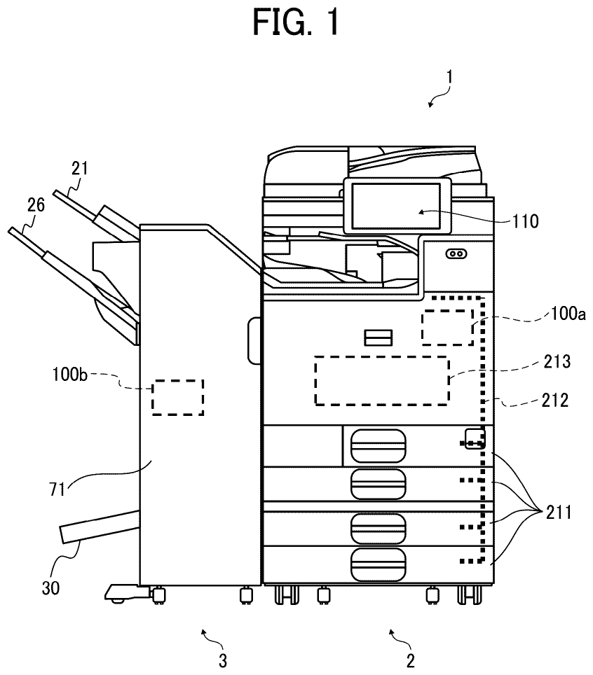

FIG. 1 is a diagram illustrating an overall configuration of the image forming system 1.

The image forming system 1 has, for example, an image forming function of forming an image on a sheet P as an example of a sheet-shaped medium and a post-processing function of performing post-processing on the sheet P on which the image has been formed. As illustrated in FIG. 1, the image forming system 1 includes an image forming apparatus 2 having the image forming function and a post-processing apparatus 3 serving as a medium processing apparatus including the post-processing function, according to an embodiment of the present disclosure. In the image forming system 1, the image forming apparatus 2 and the post-processing apparatus 3 operate in conjunction with each other.

In the present embodiment, the sheet-shaped medium to be processed in the image forming system 1 is described on the assumption that the medium is a sheet of “paper”. The object to be processed according to the present embodiment is not limited to a paper. For example, any material or specification may be used as long as an image can be formed on a medium in a known image forming process and the medium is a target of the image forming process. The medium includes a medium which can be an object of the folding process or the binding process, and the material or the specification is not limited.

The image forming apparatus 2 forms an image on the sheet P and ejects the sheet P having the image to the post-processing apparatus 3. The image forming apparatus 2 includes a sheet tray 211 that accommodates the sheet P, a conveyor 212 that conveys the sheet P accommodated in the sheet tray 211, and an image former 213 that forms an image on the sheet P conveyed by the conveyor 212. The image former 213 may be an inkjet system that forms an image using ink or an electrophotographic system that forms an image using toner. The image forming apparatus 2 also includes a controller 100a that controls various operations of the conveyor 212 and the image former 213. Since the image forming apparatus 2 has a typical configuration, a detailed description of the configuration and functions of the image forming apparatus 2 are omitted.

Sheets of paper are widely known as an example of sheet-shaped media. In the following description, a sheet-shaped medium as a medium to be processed is referred to as a “sheet P”. Further, in the following description, a bundle of sheets of paper as a plurality of media is an example of a “sheet bundle Pb”.

### First Embodiment of Post-Processing Apparatus

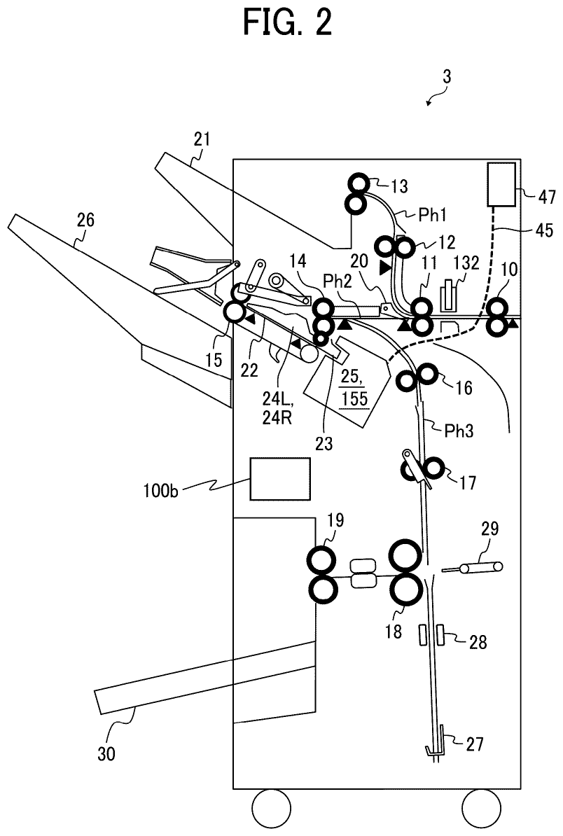

FIG. 2 is a view illustrating an internal configuration of the post-processing apparatus 3 according to the first embodiment.

The post-processing apparatus 3 has a function that performs post-processing on the sheet P on which an image has been formed by the image forming apparatus 2. An example of the post-processing according to the present embodiment is a binding process as a “crimp binding process” that binds, without staples, a plurality of sheets P on each of which an image has been formed as a bundle of sheets P, which may be referred to as a sheet bundle. Another example of the post-processing according to the present embodiment is a binding process as a “stapling process” that binds, with staples, a plurality of the sheets P on each of which an image has been formed as a bundle of sheets P, which may be referred to as a sheet bundle. In the following description, the bundle of sheets P may be referred to as a “sheet bundle Pb” as a bundle of media.

In the present embodiment, a description is given of a liquid application process in a crimp binding process. However, the liquid application process performed in a stapling process is similar to the liquid application process in the crimp binding process. In the following description, the term “binding process” indicates both the “crimp binding process” and the “stapling process”, and is not limited to a binding method (whether a binding needle is used or pressure deformation is performed).

More particularly, the “crimp binding process” according to the present embodiment is processing called “crimp binding” that applies pressure to a binding position corresponding to a part of the sheet bundle Pb to deform (pressure-deform) the binding position and binds the sheet bundle Pb. The binding that can be executed by the post-processing apparatus 3 includes an edge binding process and a saddle binding process. The edge binding process is a process to bind an end (including an edge) of the sheet bundle Pb. The saddle binding process is a process to bind the center of the sheet bundle Pb.

The post-processing apparatus 3 includes conveyance roller pairs 10 to 19 (conveyor), a switching member 20, and the like, and a controller 100b (control unit). The controller 100b controls operations of the conveyance roller pairs 10 to 19 (conveyor), the switching member 20, and the like. Details of the controller 100b will be described later.

The conveyance roller pairs 10 to 19 convey, inside the post-processing apparatus 3, the sheet P supplied from the image forming apparatus 2. More particularly, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on a sheet P conveyed by the conveyance roller pairs 10 and 11.

The first conveyance passage Ph1 is a passage extending to a first ejection tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to a second ejection tray 26 via an internal tray 22. The third conveyance passage Ph3 is a passage branching from the first conveyance passage Ph1 between the conveyance roller pairs 11 and 14 in the conveyance direction and extending to an ejection tray 30.

The switching member 20 is disposed at a branching position of the first conveyance passage Ph1 and the second conveyance passage Ph2. The switching member 20 can be switched between a first position and a second position. The switching member 20 in the first position guides the sheet P to be output to the first ejection tray 21 through the first conveyance passage Ph1. The switching member 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes multiple sensors that detects the positions of the sheet P in the first conveyance passage Ph1, the second conveyance passage Ph2, and the third conveyance passage Ph3. Note that each of the plurality of sensors is indicated by a black triangle in FIG. 2.

The post-processing apparatus 3 includes the first ejection tray 21. The sheet P output through the first conveyance passage Ph1 is placed on the first ejection tray 21.

Among the sheets P supplied from the image forming apparatus 2, the sheets P that are not bound are output to the first ejection tray 21.

The post-processing apparatus 3 further includes the internal tray 22 serving as a placement tray, an edge-binding end fence 23, side fences 24L and 24R, an edge binder 25, a staple binder 155, and a second ejection tray 26. The internal tray 22, the edge-binding end fence 23, the side fences 24L and 24R, the edge binder 25, and the staple binder 155 perform the edge binding process on the sheet bundle Pb including the plurality of sheets P conveyed from the second conveyance passage Ph2 to the internal tray 22. Among the sheets P supplied from the image forming apparatus 2, the sheet bundle Pb subjected to the edge binding is output to the second ejection tray 26.

The “edge binding process” indicates a binding process performed by the edge binder 25 and the staple binder 155. Specifically, the “edge binding process” includes, but not limited to, a “parallel binding process” that binds the sheet bundle Pb along one side of the sheet bundle Pb parallel to the main scanning direction, an “inclined binding process” that binds a corner of the sheet bundle Pb, and a “vertical binding process” that binds the sheet bundle Pb along one side of the sheet bundle Pb parallel to the conveyance direction.

In the following description, a direction in which the sheet P is conveyed from the conveyance roller pair 15 toward the edge-binding end fence 23 is defined as a “conveyance direction”. In other words, the “conveyance direction” herein corresponds to a direction in which the sheet P that has been ejected from the image forming apparatus 2 is moved toward the second ejection tray 26 by, for example, the conveyance roller pair 10 and then is moved toward the edge-binding end fence 23 by the conveyance roller pair 15, which is a direction different from the previous direction. A direction that is orthogonal to the conveyance direction and a thickness direction of the sheet P is defined as a “main scanning direction” or a “width direction of the sheet P”.

The plurality of sheets P that is sequentially conveyed through the second conveyance passage Ph2 is temporarily placed on the internal tray 22 serving as a receptacle. The edge-binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform edge binding on the sheet bundle Pb aligned by the edge-binding end fence 23 and the side fences 24L and 24R. Then, the conveyance roller pair 15 outputs the sheet bundle Pb subjected to the edge binding to the second ejection tray 26.

The post-processing apparatus 3 further includes a saddle-binding end fence 27, a saddle binder 28, a sheet folding blade 29, and the ejection tray 30. The saddle-binding end fence 27, the saddle binder 28, and the sheet folding blade 29 perform the saddle binding process on the sheet bundle Pb including the plurality of sheets P conveyed through the third conveyance passage Ph3. Among the sheets P supplied from the image forming apparatus 2, the sheet bundle Pb subjected to the saddle binding process is ejected to the ejection tray 30. The saddle-binding end fence 27 aligns the positions, in the conveyance direction, of the plurality of sheets P sequentially conveyed through the third conveyance passage Ph3. The saddle-binding end fence 27 can move between the binding position where the center of the sheet bundle Pb faces the saddle binder 28 and the folding position where the center of the sheet bundle Pb faces the sheet folding blade 29. The saddle binder 28 binds the center of the sheet bundle Pb aligned by the saddle-binding end fence 27 at the binding position. The sheet folding blade 29 folds, in half, the sheet bundle Pb placed on the saddle-binding end fence 27 at the folding position and causes the conveyance roller pair 18 to nip the sheet bundle Pb. The conveyance roller pairs 18 and 19 eject the sheet bundle Pb subjected to the saddle binding process to the ejection tray 30.

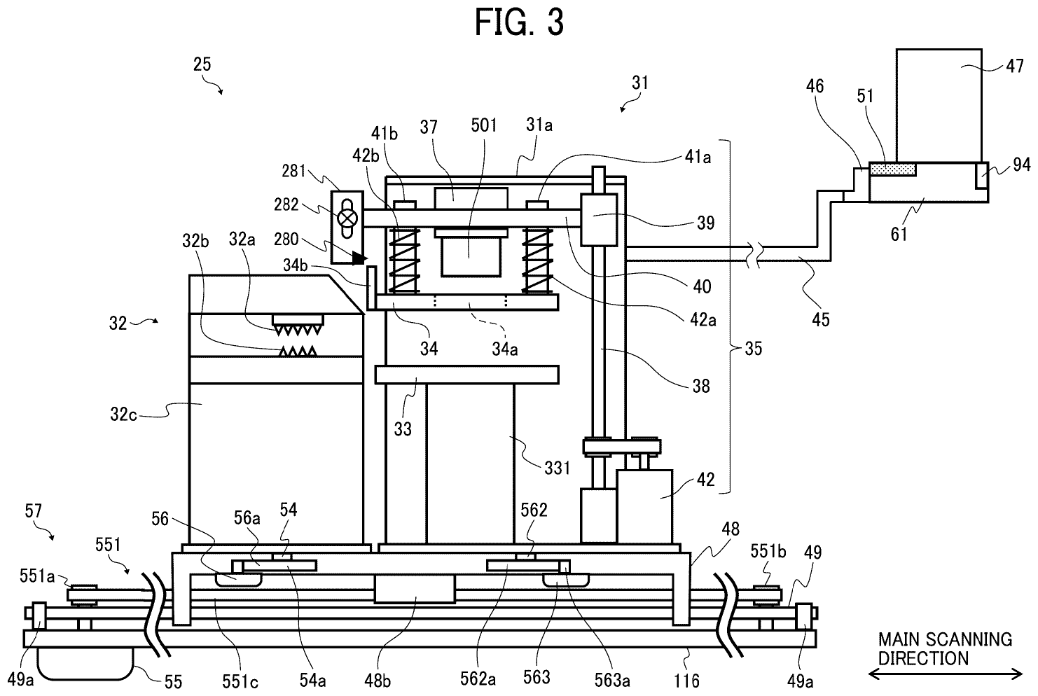

In addition, the post-processing apparatus 3 includes a liquid application member 501 (a part of the liquid applier), a liquid supply member 50 (a part of the liquid applier), and a first liquid storage tank 44 (a first liquid storage unit) in the edge binder 25. The first liquid storage tank 44 and the liquid supply member 50 are omitted in FIG. 3. The post-processing apparatus 3 includes a liquid supply passage 45 (a part of the liquid supplier), a liquid supply pump 46 (a part of the liquid supplier), a second liquid storage tank 47 (a part of the second liquid storage unit), and a second liquid storage tank fixer 61 (a part of the second liquid storage unit) as a configuration for replenishing the first liquid storage tank 44 with the liquid. The liquid that is stored in the second liquid storage tank 47 is supplied to the first liquid storage tank 44 via the second liquid storage tank fixer 61, the liquid supply pump 46, and the liquid supply passage 45.

### Configuration of Edge Binder

FIG. 3 is a schematic view of the edge binder 25, viewed from the upstream side in the conveyance direction.

The edge binder 25 performs the liquid application process and the crimp binding process illustrated in FIG. 2.

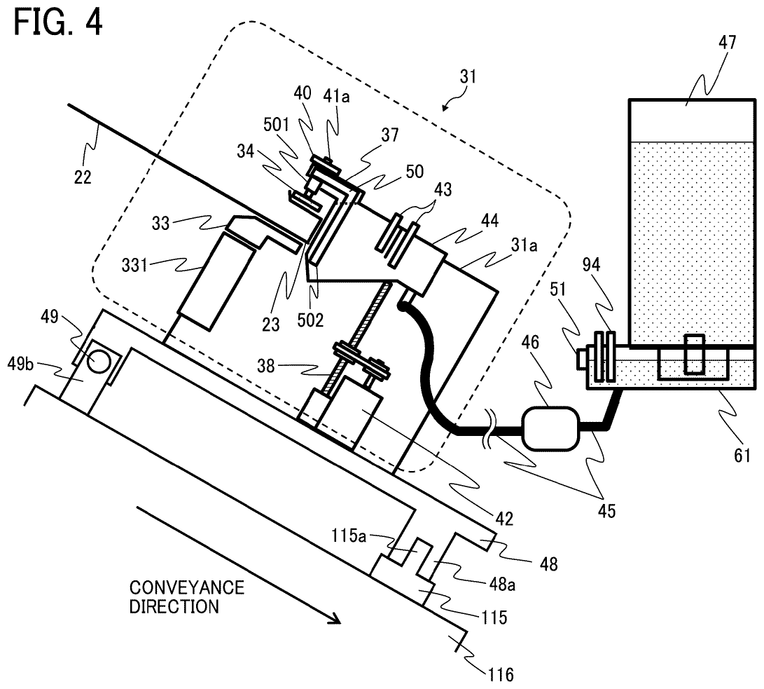

FIG. 4 is a schematic diagram of the edge binder 25 viewed from the side on which a liquid applier 31 is disposed in the main scanning direction.

As illustrated in FIG. 3, the edge binder 25 includes the liquid applier 31 that applies liquid to the sheet P or the sheet bundle Pb, and a crimper 32 that is an example of a post-processing device and performs crimp binding on the sheet bundle Pb. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid application of the liquid applier 31 involving control processing is referred to as a “liquid application process”.

The liquid stored in the first liquid storage tank 44 as liquid for the liquid application includes, as a main component, the liquid state of a liquid hydrogen-oxygen compound represented by the chemical formula “H₂O”. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

### Configuration of Liquid Applier

As illustrated in FIGS. 3 and 4, the liquid applier 31 is movable in the main scanning direction together with the crimper 32 by a driving force transmitted from an edge binder movement motor 55. The liquid applier 31 includes a lower pressure plate 33 serving as a receptacle for the sheet P or the sheet bundle Pb, an upper pressure plate 34, and a liquid applier movement assembly 35. The components of the liquid applier 31 (the lower pressure plate 33, the upper pressure plate 34, the liquid applier movement assembly 35, and a liquid applier movement motor 42) are held by a liquid application frame 31a and a base 48.

As illustrated in FIGS. 3 and 4, the liquid applier 31 is provided side by side with the crimper 32. A liquid applying assembly 36 is connected to the liquid applier movement assembly 35 via a liquid applying assembly base 40. The liquid applying assembly 36 can move up and down integrally with the liquid applying assembly base 40.

The upper pressure plate 34 is held by the liquid applying assembly base 40 and is pressed downward by coil springs 42a and 42b. An upper pressure plate position detection shutter unit 34b is disposed on the upper pressure plate 34. In addition, an upper pressure plate position detection sensor 280 as a medium pressing position detector that detects the upper pressure plate position detection shutter unit 34b is disposed and fixed to the liquid applying assembly base 40 via an upper pressure plate position detection sensor mounting bracket 281. The upper pressure plate position detection sensor 280 is fixed by an upper pressure plate position detection sensor adjusting screw 282 so as to be able to adjust a mounting position of the upper pressure plate position detection sensor 280 in the vertical direction with respect to the liquid applying assembly base 40.

The first liquid storage tank 44 for storing a liquid for a liquid application process is provided behind the liquid applier 31, and the liquid is supplied to the tip portion of the liquid application member 501 by the liquid supply passage 45. At a tip portion of the liquid applier 31 in contact with the sheet P, the liquid application member 501 that holds liquid such as a sponge is disposed and is connected to the liquid supply passage 45.

A liquid applier shaft 562 including a drive transmission gear 562a is fixed to a bottom face of the liquid application frame 31a that holds the components of the liquid applier 31. The liquid applier shaft 562 and the drive transmission gear 562a are held by the base 48 on which the liquid application frame 3 la is disposed, so as to be rotatable in the forward and reverse directions. The drive transmission gear 562a meshes with an output gear 563a of a liquid applier pivot motor 563. The liquid applier 31 can be rotated in the forward and reverse directions about the liquid applier shaft 562 on the base 48 by a driving force transmitted from the liquid applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is provided on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction”. Further, the upper pressure plate 34 is provided with a through hole 34a passing through the upper pressure plate 34 in the thickness direction at a position opposite to the liquid application member 501 held via the holder 37 attached to the liquid applying assembly base 40.

The through hole 34a is provided to penetrate a part of the upper pressure plate 34 as a medium pressing unit so that the liquid application member 501 can protrude to a contactable position to apply liquid to the sheet P. The through hole 34a is opened so that the liquid application member 501 is retractable (movable) when the liquid application member 501 is not applying liquid. In other words, the through hole 34a of the upper pressure plate 34 is formed so that the liquid application member 501 can advance or retract (move) with respect to the sheet P or the sheet bundle Pb. The liquid application member 501 is one end portion of a liquid supply member 50 (liquid absorber) described below and corresponds to a tip portion of the liquid supply member 50.

The liquid applier movement assembly 35 moves the upper pressure plate 34, the liquid applying assembly base 40, the holder 37, the liquid application member 501, the liquid supply member 50, and the first liquid storage tank 44 in the thickness direction of the sheet P or the sheet bundle Pb. The liquid applier movement assembly 35 according to the present embodiment moves the upper pressure plate 34, the liquid applying assembly base 40, the holder 37, the liquid application member 501, the liquid supply member 50, and the first liquid storage tank 44 in conjunction with each other with the single liquid applier movement motor 42. The liquid applier movement assembly 35 includes, for example, a liquid applier movement motor 42, a trapezoidal screw 38, a nut 39, the liquid applying assembly base 40, columns 41a and 41b, and the coil springs 42a and 42b.

The liquid applier movement motor 42 generates a driving force to move the upper pressure plate 34, the liquid applying assembly base 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 3 la so that the trapezoidal screw 38 is rotatable in the forward and reverse directions. The trapezoidal screw 38 is coupled to an output shaft of the liquid applier movement motor 42 via, for example, a pulley and a belt. The nut 39 is screwed to the trapezoidal screw 38. The trapezoidal screw 38 is rotated in the forward and reverse directions by the driving force transmitted from the liquid applier movement motor 42. The rotation of the trapezoidal screw 38 causes the nut 39 to reciprocate on the trapezoidal screw 38.

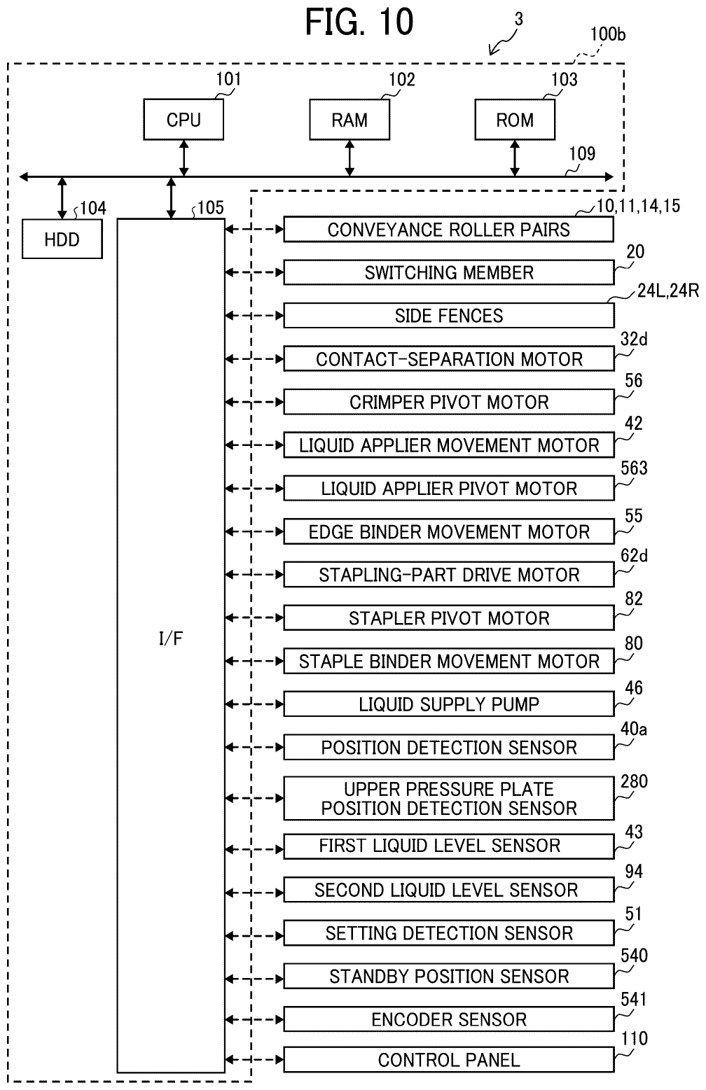

The liquid applying assembly base 40 is arranged apart from the upper pressure plate 34. The liquid applying assembly base 40 holds the liquid application member 501 with the tip portion of the liquid application member 501 protruding from the liquid applying assembly base 40 toward the upper pressure plate 34. The liquid applying assembly base 40 is coupled to the trapezoidal screw 38 via the nut 39, and is enabled to reciprocate along the trapezoidal screw 38 by rotation of the trapezoidal screw 38 in the forward and reverse directions. A position of the liquid applying assembly base 40 in the thickness direction of the sheet P or the sheet bundle Pb is detected by a position detection sensor 40a (see FIG. 10).

The columns 41a and 41b protrude from the liquid applying assembly base 40 toward the upper pressure plate 34 around tip ends of the liquid application member 501. The columns 41a and 41b relatively move with respect to the liquid applying assembly base 40 in the thickness direction. The columns 41a and 41b hold the upper pressure plate 34 with the respective tip ends closer to the lower pressure plate 33 than the other ends of the columns 41a and 41. The other ends of the columns 41a and 41b opposite the tip ends closer to the lower pressure plate 33 are provided with stoppers that prevent the columns 41a and 41b from being removed from the liquid applying assembly base 40.

The coil springs 42a and 42b are fitted around the columns 41a and 41b, respectively, between the liquid applying assembly base 40 and the upper pressure plate 34. The coil springs 42a and 42b bias the upper pressure plate 34 and the columns 41a and 41b toward the lower pressure plate 33 with respect to the liquid applying assembly base 40.

The liquid applier 31 applies liquid to the sheet P or the sheet bundle Pb placed on the internal tray 22. More particularly, the liquid applier 31 brings the liquid application member 501 into contact with the sheet P or the sheet bundle Pb to apply the liquid to at least one sheet P of the sheet bundle Pb.

The liquid applier 31 includes a first liquid level sensor 43 (serving as a first liquid detector), the first liquid storage tank 44, the liquid application member 501, the liquid supply member 50, and the holder 37. The first liquid storage tank 44 stores the liquid to be applied to the sheet P or the sheet bundle Pb. The amount of liquid that is stored in the first liquid storage tank 44 is detected by the first liquid level sensor 43. The first liquid storage tank 44 is coupled to the liquid applying assembly base 40 via the holder 37. The liquid application member 501 applies the liquid stored in the first liquid storage tank 44 to the sheet P or the sheet bundle Pb. The liquid application member 501, the liquid supply member 50 (liquid absorber) disposed in close contact with the liquid application member 501, and the first liquid storage tank 44 are held by the holder 37. The holder 37 is held by the liquid applying assembly base 40. One end portion of the liquid supply member 50 is in close contact with the liquid application member 501, and the other end portion of the liquid supply member 50 is immersed in the liquid stored in the first liquid storage tank 44. In other words, the other end of the liquid supply member 50 corresponds to a liquid immersion portion 502 that draws up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular type as long as the at least one of the liquid application member 501 or the liquid supply member 50 is made of a material having properties of absorbing and holding the liquid and has a property of being crushable in accordance with a pressing force applied when the at least one of the liquid application member 501 or the liquid supply member 50 is in contact with the sheet P. In other words, the material may be any material as long as the material can absorb or draw up liquid by capillary action.

Accordingly, when the other end portion (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from the liquid immersion portion 502 of the liquid supply member 50, and the sucked liquid is supplied to the liquid application member 501 that is coupled to the tip portion via the liquid supply member 50. Then, the liquid stored in the first liquid storage tank 44 is drawn up to the liquid application member 501 in close contact with one end portion of the liquid supply member 50, and thus the liquid level (stored liquid amount) of the liquid stored in the first liquid storage tank 44 detected by the first liquid level sensor 43 is lowered. As a result, the liquid is supplied from the second liquid storage tank 47 to the first liquid storage tank 44 by the liquid supply pump 46.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid stored in the first liquid storage tank 44. By so doing, the amount of liquid (liquid level) in the first liquid storage tank 44 temporarily decreases to the level below the reference liquid level described below. In response to this decrease of liquid in the first liquid storage tank 44, a series of liquid supplying operations for feeding liquid from the second liquid storage tank 47 to the first liquid storage tank 44 is performed. This series of liquid supply operations is mainly performed at the time of activation of the post-processing apparatus 3 or at the time of start of execution of the binding processing involving liquid application in the post-processing apparatus 3, and corresponds to the liquid supply operations for bringing the liquid application using the liquid application member 501 to be executable.

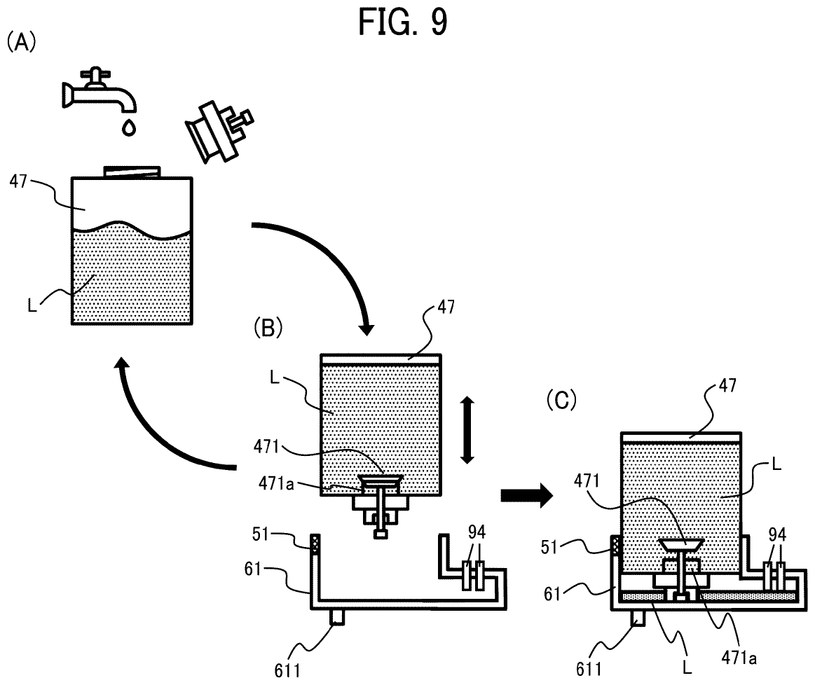

The edge binder 25 or the post-processing apparatus 3 is provided with the second liquid storage tank 47. The second liquid storage tank 47 is attachable to and detachable from the second liquid storage tank fixer 61 (a part of the second liquid storage) disposed in the edge binder 25 or the post-processing apparatus 3 (see FIG. 9). The second liquid storage tank 47 is fixed (set) to the second liquid storage tank fixer 61 (a part of the second liquid storage unit) at a given position. By so doing, the liquid already stored in the second liquid storage tank 47 can be supplied to the first liquid storage tank 44.

The operation to supply liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by liquid application by the liquid applier 31. In other words, the operation to supply liquid from the second liquid storage tank 47 to the first liquid storage tank 44 corresponds to the liquid supply operation in accordance with the execution of the job including liquid application by the liquid applier 31.

This liquid supplying operation corresponds to an operation of supplying liquid to the first liquid storage tank 44 so as to replenish liquid each time the stored liquid amount (liquid level) of the first liquid storage tank 44 falls below a reference liquid level, which is described below.

When the second liquid storage tank 47 is set in the second liquid storage tank fixer 61, the second liquid storage tank fixer 61 is filled with a certain amount of the liquid in the second liquid storage tank 47. The second liquid storage tank fixer 61 is provided with a setting detection sensor 51 (set detector) (see FIG. 9(B)). When the setting detection sensor 51 detects the set state of the second liquid storage tank 47 to the second liquid storage tank fixer 61 (see FIG. 9(C)), a signal indicating the set state is transmitted to the controller 100b, which is described below. Thus, the controller 100b to be described below detects whether the second liquid storage tank 47 is mounted to the second liquid storage tank fixer 61.

Details of the second liquid storage tank 47 will be described below.

The first liquid storage tank 44 and the second liquid storage tank 47 are coupled to each other by the liquid supply passage 45. The liquid supply pump 46 is disposed near the second liquid storage tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Therefore, the second liquid storage tank fixer 61 is a component of the liquid supplier that executes a liquid supply operation to supply liquid from the second liquid storage tank 47 to the first liquid storage tank 44. The liquid supply passage 45 includes a flexible material. Accordingly, even if the first liquid storage tank 44 is moved by the liquid applier movement assembly 35, liquid can be supplied from the second liquid storage tank 47 to the first liquid storage tank 44.

The supply of liquid from the second liquid storage tank 47 to the first liquid storage tank 44 can be controlled in accordance with the detection result of the first liquid level sensor 43. In other words, the controller 100b, which is described below, determines whether the stored liquid amount (liquid level) in the first liquid storage tank 44 based on the detection result of the first liquid level sensor 43. In accordance with the determined stored liquid amount (liquid level) of the first liquid storage tank 44, the controller 100b controls the operation speed and time of the liquid supply pump 46. By so doing, the controller 100b can adjust the amount of liquid to be replenished to the first liquid storage tank 44 to maintain the stored liquid amount (liquid level) in the first liquid storage tank 44 at a constant level of liquid.

### Configuration of Crimper

As illustrated in FIG. 3, the crimper 32 as a post-processing device presses and deforms at least a portion (liquid application position) of the sheet bundle Pb, to which liquid has been applied by the liquid applier 31, by serrated upper crimping teeth 32a and lower crimping teeth 32b, and crimps the sheets P of the portion to bind the sheet bundle Pb. In other words, the crimper 32 can bind the sheet bundle Pb without staples. The components of the crimper 32 such as the upper crimping teeth 32a and the lower crimping teeth 32b are disposed on a crimping frame 32c. Hereinafter, binding by pressing and deforming a given position of the sheet bundle Pb by the crimper 32 will be simply referred to as “crimp binding”. The crimping and binding operation of the crimper 32 that involves control processing is referred to as “crimp binding process”.

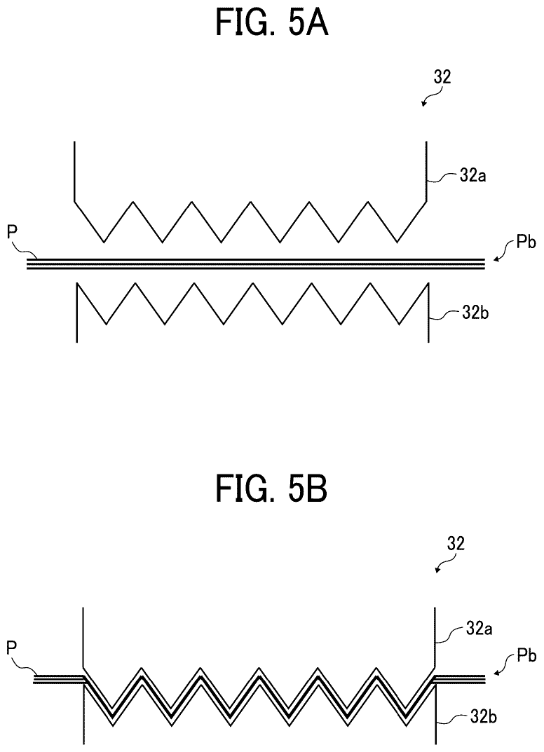

FIGS. 5A and 5B are schematic diagrams illustrating the configuration of the crimper 32.

As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b so that the upper crimping teeth 32a are engaged with the lower crimping teeth 32b. The upper crimping teeth 32a and the lower crimping teeth 32b are brought into contact with and separated from each other by the driving force of a contact-separation motor 32d illustrated in FIG. 10.

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is output to the second ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57. The edge binder movement assembly 57 moves the edge binder 25 (in other words, the liquid applier 31 and the crimper 32) in the main scanning direction along the downstream end of the sheet P, which is placed on the internal tray 22, in the conveyance direction. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 10).

The liquid applier 31 and the crimper 32 are attached to the base 48 so that the liquid applier 31 and the crimper 32 are adjacent to each other in the main scanning direction. As illustrated in FIG. 4, the guide shaft 49 is held by multiple guide shaft brackets 49a disposed in the main scanning direction at a position on the upstream side of a binding assembly base 116 in the conveyance direction of the sheet P. As illustrated in FIG. 3, the guide shaft 49 extends in the main scanning direction on the binding assembly base 116. The guide rail 115 is disposed in the main scanning direction on the downstream side of the binding assembly base 116 in the conveyance direction. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge binder movement motor 55 according to the present embodiment is, for example, a servo motor that can stop the edge binder 25 at a target position (for example, a first binding position B1 described below) without returning the edge binder 25 to an origin position (for example, a standby position HP described below) every time the edge binder 25 is moved. The post-processing apparatus 3 includes the standby position sensor 540 (for example, a light shielding optical sensor, see FIG. 10) that detects that the edge binder 25 has reached the standby position HP (see FIG. 9(A)), and an encoder sensor 541 (see FIG. 10) attached to an output shaft of the edge binder movement motor 55. The controller 100b, which will be described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects the arrival of the edge binder 25 at a given target position determined in advance.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

### Configuration of Staple Binder

Specifically, a detailed description is now given of the staple binder 155 having a function of executing a stapling process.

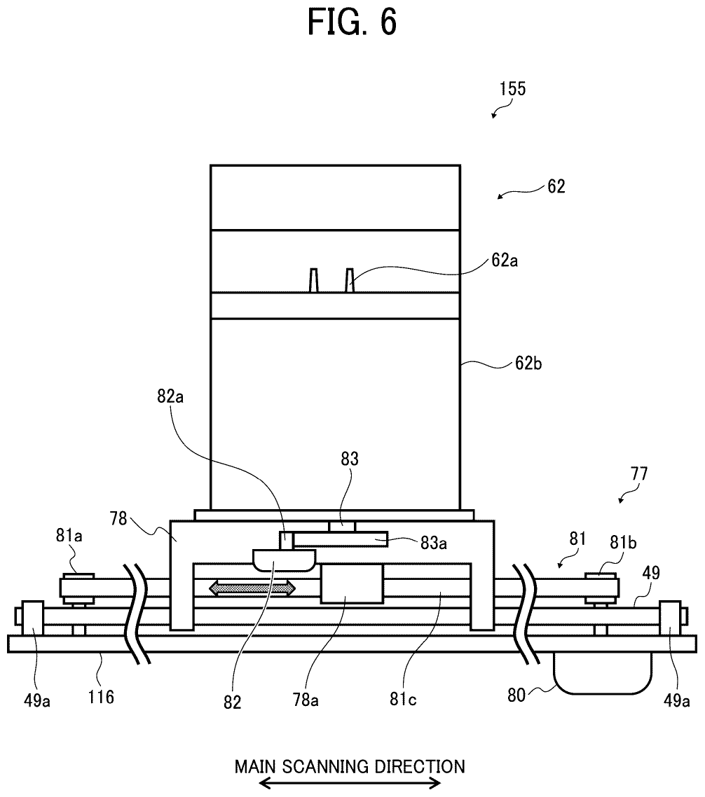

FIG. 6 is a schematic view of the staple binder 155 as viewed from the upstream side in the conveyance direction.

The staple binder 155 includes a stapler 62 that binds the sheet bundle Pb with staples. The stapler 62 is disposed downstream from the internal tray 22 in the conveyance direction and spaced apart from the edge binder 25 in the main scanning direction.

The stapler 62 serving as a post-processing device has a configuration of performing so-called “stapling process” to bind the sheet bundle Pb with a staple. More particularly, the stapler 62 includes a stapling-part drive motor 62d illustrated in FIG. 10. The stapling-part drive motor 62d drives a stapling part 62a. The driving force of the stapling-part drive motor 62d causes a staple loaded in the stapling part 62a to penetrate through a sheet bundle Pb, so that the stapling part 62a binds the sheet bundle Pb. Since the stapler 62 has a typical configuration, a detailed description thereof will be omitted unless otherwise required.

As illustrated in FIG. 6, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can independently move the edge binder 25 and the staple binder 155.

### Configuration of Modification of Staple Binder

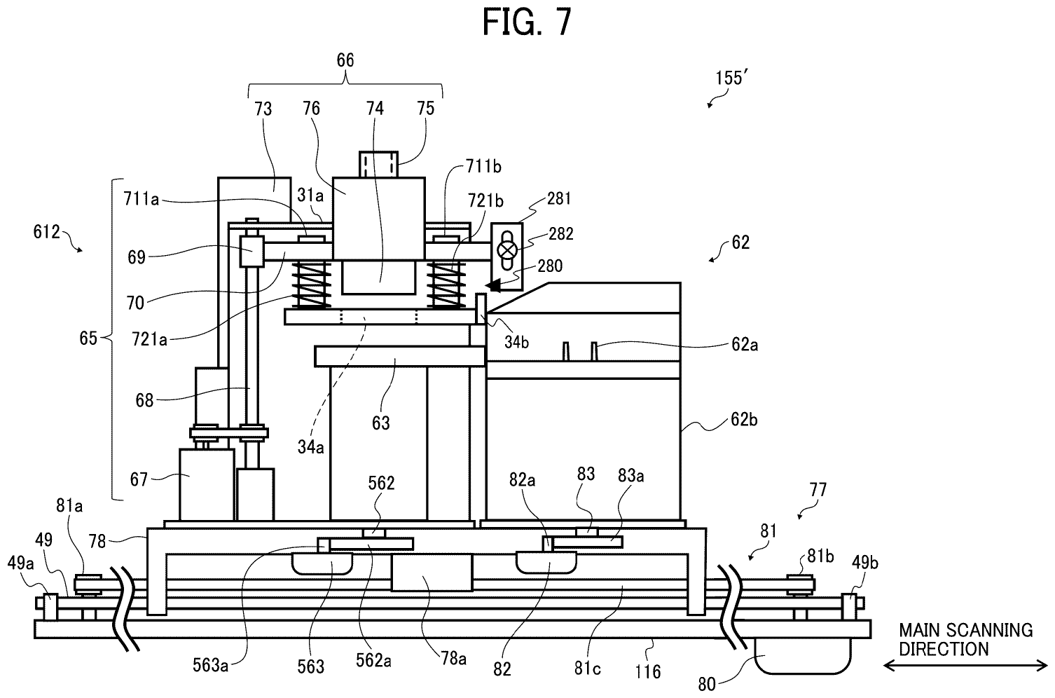

FIG. 7 illustrates a staple binder 155′ as a modification of the staple binder 155.

Specifically, FIG. 7 is a view of an upstream side of the staple binder 155′ in the conveyance direction. The staple binder 155′ is different from the staple binder 155 in that the staple binder 155′ includes a second liquid applier 612 in addition to the stapler 62. As illustrated in FIG. 7, the staple binder 155′ includes the second liquid applier 612 and the stapler 62. The second liquid applier 612 and the stapler 62 are disposed downstream from the internal tray 22 in the conveyance direction of the sheet P and adjacent to each other in the main scanning direction.

The second liquid applier 612 executes liquid application of applying liquid stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 7, the second liquid applier 612 includes a second lower pressure plate 63, a second upper pressure plate 64, a second liquid applier movement assembly 65, and a second liquid applying assembly 66. The second liquid applier movement assembly 65 includes, for example, a second liquid applier moving motor 67, a second trapezoidal screw 68, a second nut 69, a second base plate 70, second columns 711a and 711b, and second coil springs 721a and 721b.

The second liquid applying assembly 66 includes the third liquid storage tank 73, a second liquid supply portion 75, a second liquid application member 74, and a second joint 76. Since the second liquid applying assembly 66 and the liquid applying assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted unless otherwise required.

Since the stapler 62 has a configuration similar to the configuration of the staple binder 155 illustrated in FIG. 6, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes the liquid applier pivot motor 563, the output gear 563a, the drive transmission gear 562a, and the liquid applier shaft 562.

As with the staple binder 155′ illustrated in FIG. 7, when the liquid application is also performed on the sheet P in the stapling process, the binding position is loosened and softened, thus allowing the staple to easily pass through. As a result, the number of sheets to be bound per sheet bundle Pb can be increased as compared with a case where the stapling process is performed without applying the liquid.

Configuration of Second Liquid Storage Tank

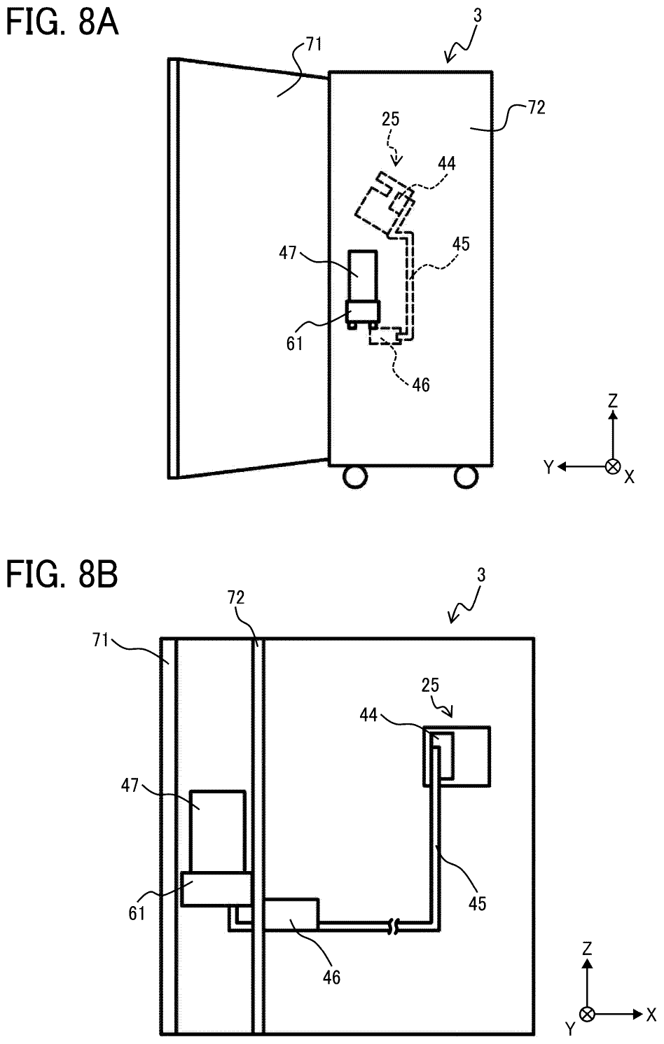

Referring now to FIGS. 8A, 8B and 9 (9 A), 9 B) and 9(C)), a description is given of the arrangement and configuration of the second liquid storage tank 47 in the post-processing apparatus 3.

FIGS. 8A and 8B illustrate example location and configuration of the second liquid storage tank 47 as the main tank.

FIG. 8A illustrates a state in which an opening/closing cover 71 of the post-processing apparatus 3 is opened.

FIG. 8B is a cross-sectional side view of the post-processing apparatus 3, illustrating the post-processing apparatus 3 with the opening/closing cover 71 closed.

As illustrated in FIGS. 8A and 8B, the second liquid storage tank 47 is located so as to be accessible when the opening/closing cover 71 of the post-processing apparatus 3 is opened. As illustrated in FIG. 8B, the second liquid storage tank 47 and the second liquid storage tank fixer 61 are disposed on the near side in a depth direction (X direction) of the post-processing apparatus 3. The first liquid storage tank 44 is disposed on the far side in the depth direction (X direction) of the post-processing apparatus 3. A main body side plate 72 of the post-processing apparatus 3 is disposed between the arrangement position of the second liquid storage tank 47 and the second liquid storage tank fixer 61 and the arrangement position of the first liquid storage tank 44. The second liquid storage tank fixer 61 is attached to the main body side plate 72 of the post-processing apparatus 3.

FIG. 9 including FIGS. 9(A), 9(B) and 9(C) illustrates the second liquid storage tank 47 attachable to and detachable from the second liquid storage tank fixer 61 and a state where liquid is replenished to the second liquid storage tank 47.

As illustrated in FIG. 9(A), the second liquid storage tank 47 is attachable to and detachable from the second liquid storage tank fixer 61 so that liquid L can be replenished to the first liquid storage tank 44. As illustrated in FIG. 9(B), the second liquid storage tank fixer 61 is provided with the setting detection sensor 51 serving as a set detector that detects that the second liquid storage tank 47 is set in the second liquid storage tank fixer 61.

When the setting detection sensor 51 detects the set state of the second liquid storage tank 47 to the second liquid storage tank fixer 61 (see FIG. 9(C)), a signal indicating the set state is transmitted to the controller 100b, which is described below. Thus, the controller 100b to be described below detects whether the second liquid storage tank 47 is mounted on the second liquid storage tank fixer 61.

The second liquid storage tank fixer 61 is provided with a second liquid level sensor 94 (serving as second liquid detector) that detects the amount of liquid L to be stored in the second liquid storage tank 47. The output value (voltage) of the second liquid level sensor 94 is notified to the controller 100b described later. Then, the controller 100b described later determines an output value (voltage) of the second liquid level sensor 94 to determine whether the liquid storage amount of the second liquid storage tank fixer 61 is a necessary liquid amount. When determining that the second liquid storage tank 47 is in the set state according to the output signal of the setting detection sensor 51, the controller 100b described later turns on the second liquid level sensor 94 to make it possible to detect the presence or absence (liquid level) of the liquid in the second liquid storage tank fixer 61.

When the second liquid storage tank 47 is not set on the second liquid storage tank fixer 61 (i.e., is in a non-set state), a liquid discharge port 471a of the second liquid storage tank 47 is closed by a liquid supply valve 471 so that liquid L does not leak. As illustrated in FIG. 9(C), when the second liquid storage tank 47 is set in the second liquid storage tank fixer 61, the liquid supply valve 471 is pushed up to open the liquid discharge port 471a of the second liquid storage tank 47. Thus, the liquid L flows out from the second liquid storage tank 47 to the second liquid storage tank fixer 61. As a result, the liquid L stored in the second liquid storage tank 47 flows out to the second liquid storage tank fixer 61. The liquid L flown from the second liquid storage tank 47 is temporarily stored in the second liquid storage tank fixer 61.

As a measurement to prevent the liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid supply passage 45 is fed in the reverse direction to the second liquid storage tank fixer 61 via the liquid supply passage 45 by the liquid supply pump 46. In order to deal with such a situation, the second liquid storage tank fixer 61 is set to the amount to sufficiently store liquid in the first liquid storage tank 44 and the liquid supply passage 45. As illustrated in FIGS. 9(B) and 9(C), the second liquid storage tank fixer 61 is provided with a liquid drain plug 611. After the liquid L remaining in the first liquid storage tank 44 and the liquid supply passage 45 is reversely fed by the liquid supply pump 46 to the second liquid storage tank fixer 61, the liquid drain plug 611 is opened to discharge the liquid L stored in the second liquid storage tank fixer 61 from the inside of the post-processing apparatus 3.

Configuration of Control Block of Post-Processing Apparatus

A description is given below of a control block of the post-processing apparatus 3 with reference to FIG. 10.

FIG. 10 is a block diagram illustrating a hardware configuration for executing control processing in the post-processing apparatus 3.

As illustrated in FIG. 10, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b (control unit) serving as a control device that controls the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid supply pump 46, the position detection sensor 40a, the upper pressure plate position detection sensor 280, the first liquid level sensor 43, the second liquid level sensor 94, the setting detection sensor 51, the standby position sensor 540, the encoder sensor 541, and a control panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, and the liquid supply pump 46. The controller 100b acquires detection results of the position detection sensor 40a, the upper pressure plate position detection sensor 280, the first liquid level sensor 43, the second liquid level sensor 94, the setting detection sensor 51, the standby position sensor 540, and the encoder sensor 541. Although FIG. 10 illustrates only the components related to the edge binder 25 and the staple binder 155 that perform the edge binding, the components related to the saddle binder 28 that performs the saddle binding process are also controlled by the controller 100b.

As illustrated in FIG. 1, the image forming apparatus 2 includes the control panel 110. The control panel 110 includes an operation unit that receives instructions input by a user and a display serving as a notifier that notifies the user of information. The operation unit includes, for example, physical input buttons and a touch screen overlaid on a display. The control panel 110 acquires information from the user through the operation unit and provides the information to the user through the display. A specific example of the notification unit is not limited to the display and may be a light emitting diode (LED) lamp or a speaker. The post-processing apparatus 3 may include the control panel 110 similar to the above-described control panel 110 of the image forming apparatus 2.

As described above, the post-processing apparatus 3 implements the function of performing operation control related to the liquid application by software (control programs) executed by the CPU 101 with hardware resources included in the controller 100b.

In some embodiments, the liquid application performed by the post-processing apparatus 3 may be performed in a form in which the staple binder 155 is provided with only the stapler 62 and the liquid application is performed using the liquid applier 31 of the edge binder 25. Conversely, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration of moving along the guide shaft 49 with the stapler 62 and the second liquid applier 612 being integrated, the embodiments of the present disclosure are not limited to the above-described configuration. For example, the stapler 62 and the second liquid applier 612 may have a configuration of moving separately from each other.

### Description of Binding Processing

A description is given below of the binding process executed by the edge binder 25 included in the post-processing apparatus 3.

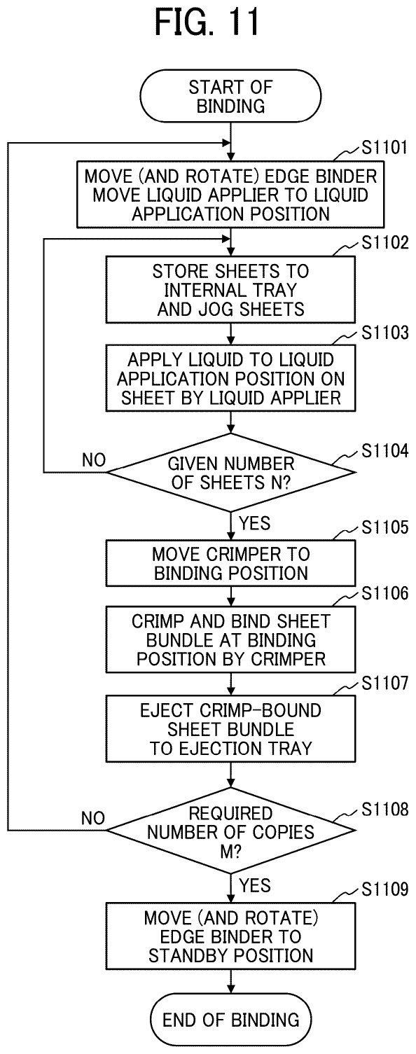

FIG. 11 is a flowchart of a process of executing one-point binding.

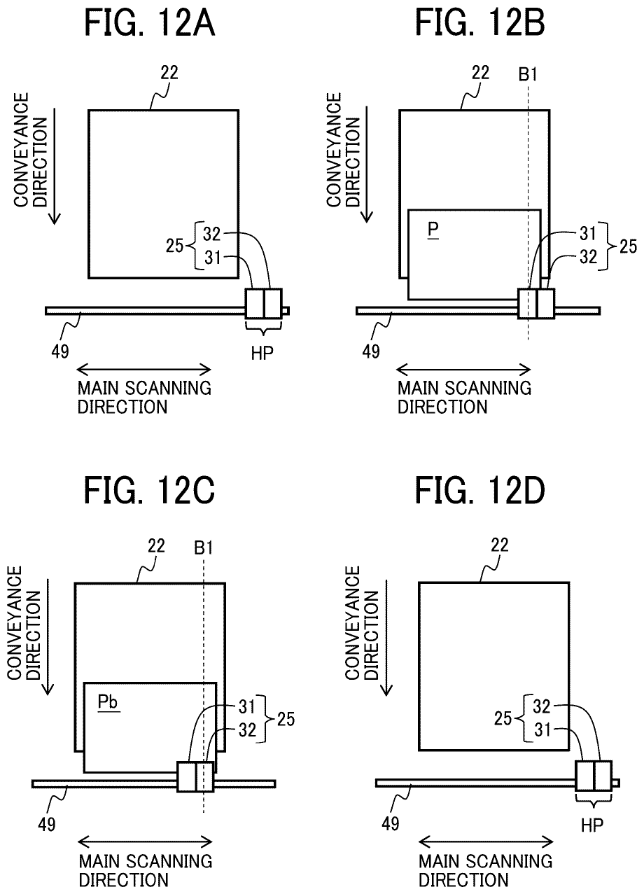

FIGS. 12A, 12B, 12C, and 12D are diagrams illustrating the position shift of the edge binder 25 (the liquid applier 31 and the crimper 32) during the one-point binding.

In FIGS. 12A, 12B, 12C, and 12D, the changes in the postures of the liquid applier 31 and the crimper 32 are omitted. The position (liquid application position) at which liquid application is executed on the sheet P or the sheet bundle Pb by the liquid applier 31 corresponds to the binding position on the sheet bundle Pb to be crimped and bound by the crimper 32. For this reason, in the following description, the liquid application position and the binding position are denoted by the same reference numeral (B1 and B2).

For example, the controller 100b starts the parallel binding process illustrated in FIG. 11 when the controller 100b acquires an instruction to execute the binding process from the image forming apparatus 2. In the following description, the instruction to execute the binding process may be referred to as a “binding command”.

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M”. The liquid applier 31 and the crimper 32 are assumed to be in a parallel binding posture and located at a standby position HP (FIG. 12A) that is a position away in the width direction from the sheets P placed on the internal tray 22 at the start of the binding process.

When the posture that is instructed by the binding command is the “inclined binding posture”, the controller 100b drives the crimper pivot motor 56 to rotate the crimper 32 constituting the edge binder 25 into the inclined binding posture (step S1101). The controller 100b causes the liquid applier pivot assembly 126 to rotate the liquid applier 31 of the edge binder 25 to the inclined binding posture. When the posture is the “inclined binding posture”, the crimper 32 alone may be rotated to the inclined binding posture and the liquid applier 31 may be restricted not to rotate in the forward and reverse directions. As a result, the driving assembly may be simplified as compared with a case where both the liquid applier 31 and the crimper 32 are rotated in the forward and reverse directions, and thus effects of cost reduction, downsizing of the apparatus, and reduction of failure of the device are exhibited.

On the other hand, when the posture that is instructed by the binding command is the “parallel binding posture”, the controller 100b omits the aforementioned operation of rotating the liquid applier 31 and the crimper 32 of the edge binder 25 to the inclined binding posture. The controller 100b drives the edge binder movement motor 55 to move the edge binder 25 in the main scanning direction so that the liquid applier 31 faces the first liquid application position B1 instructed by the binding command (step S1101). The controller 100b executes the operation of step S1101 before a first sheet P is conveyed to the internal tray 22 by the conveyance roller pairs 10, 11, 14, and 15.

The controller 100b rotates the conveyance roller pairs 10, 11, 14, and 15 to accommodate the sheet P on which an image has been formed by the image forming apparatus 2 on the internal tray 22 (S1102). The controller 100b moves the side fences 24L and 24R to align the position of the sheet P or the sheet bundle Pb placed on the internal tray 22 in the main scanning direction, that is, execute so-called jogging (S1102).

The controller 100b causes the liquid applier 31 facing the first liquid application position B1 to apply liquid to the first liquid application position B1 of the sheet P placed on the internal tray 22 in the immediately preceding step S1102, based on the liquid application control data adjusted in advance (step S1103). In other words, the controller 100b drives the liquid applier movement motor 42 to bring the liquid application member 451 into contact with the first liquid application position B1 on the sheet P placed on the internal tray 22 (see FIG. 12B). In the liquid application process in step S1103, the controller 100b adjusts the position at which the liquid application member 451 applies the liquid to the sheet P according to the type of the sheet P included in the binding process instruction and the binding position. The controller 100b adjusts the amount of pressing the liquid application member 451 against the sheet P. That is, the controller 100b controls the driving of the liquid applier movement motor 42 on the basis of the adjusted control data to adjust the movement amount of the liquid application member 451 with respect to the binding position B1 of the sheet P placed on the internal tray 22.

The controller 100b determines whether the number of sheets P placed on the internal tray 22 has reached the given number of sheets N instructed by the binding command (step S1104). When the controller 100b determines that the number of sheets P placed on the internal tray 22 has not reached the given number of sheets N (NO in step S1104), the controller 100b executes the operations of steps S1102 to S1104 again until the number of sheets P placed on the internal tray 22 reaches the given number of sheets N (YES in step S1104).

In other words, the controller 100b executes the processing of steps S1102 to S1104 each time the sheet P is conveyed to the internal tray 22 by the conveyance roller pairs 10, 11, 14, and 15. The liquid application by the liquid applier 31 may be performed on each of the multiple sheets P of the sheet bundle Pb. When the controller 100b determines that the number of sheets P placed on the internal tray 22 has reached the given number of sheets N (YES in step S1104), the controller 100b drives the edge binder movement motor 55 to move the edge binder 25 in the main scanning direction so that the crimper 32 faces the first binding position B1 as illustrated in FIG. 12C (step S1105).

The controller 100b causes the crimper 32 to crimp the sheet bundle Pb placed on the internal tray 22 (step S1106). Then, the controller 100b causes the conveyance roller pair 15 to eject the sheet bundle Pb thus crimped and bound by the crimper 32 to the second ejection tray 26 (step S1107). Specifically, the controller 100b drives the contact-separation motor 32d to cause the upper crimping teeth 32a and the lower crimping teeth 32b to nip the first binding position B1 on the sheet bundle Pb placed on the internal tray 22. The sheet bundle Pb is pressed and deformed between the upper crimping teeth 32a and the lower crimping teeth 32b. Thus, the crimper 32 crimps the sheet bundle Pb. Thereafter, the controller 100b rotates the conveyance roller pair 15 to eject the crimped and bound sheet bundle Pb to the second ejection tray 26.

The sheet bundle Pb that is placed on the internal tray 22 has a crimping area (corresponding to the first binding position B1) sandwiched between the upper crimping teeth 32a and the lower crimping teeth 32b in step S1106. The crimping area overlaps a liquid application area (corresponding to the first liquid application position B1) contacted by the tip portion of the liquid application member 451 in step S1103. In other words, the crimper 32 crimps an area to which liquid is applied by the liquid applier 31 on the sheet bundle Pb placed on the internal tray 22. The crimping area sandwiched by the upper crimping teeth 32a and the lower crimping teeth 32b does not have to completely overlap the liquid application area contacted by the end of the liquid application member 451, and can obtain a sufficient binding strength even in a case where the crimping area partially overlaps the liquid application area.

The controller 100b determines whether the number of sheet bundles Pb thus ejected to the second ejection tray 26 has reached the requested number of copies M indicated by the binding command (step S1108). When the controller 100b determines that the number of sheet bundles Pb thus ejected has not reached the requested number of copies M (NO in step S1108), the controller 100b executes the operations of step S1102 and the following steps again. In other words, when the controller 100b determines that the number of sheet bundles Pb thus ejected has not reached the requested number of copies M (YES in step S1108), the controller 100b repeats the operations of steps S1102 to S1108 until the number of sheet bundles Pb ejected to the second ejection tray 26 reaches the requested number of copies M.

On the other hand, when the controller 100b determines that the number of sheet bundles Pb output to the second ejection tray 26 has reached the requested number of copies M (YES in step S1108), the controller 100b drives the edge binder movement motor 55 to move the edge binder 25 (the liquid applier 31 and the crimper 32) to the standby position HP as illustrated in FIG. 12D (step S1109). When the posture that is instructed by the binding command is the “inclined binding posture”, the controller 100b also drives the crimper pivot motor 56 to rotate the crimper 32 into the parallel binding posture (step S1109). The controller 100b causes the liquid applier pivot assembly 126 to rotate the liquid applier 31 to the parallel binding posture (step S1109). On the other hand, when the posture that is instructed by the binding command is the “parallel binding posture”, the controller 100b skips the aforementioned operation of rotating the liquid applier 31 and the crimper 32 to the parallel binding posture. As a result, the edge binder 25 (the liquid applier 31 and the crimper 32) returns to the standby position HP as illustrated in FIG. 12D. In steps S1101 and S1109, the execution order of the movement in the main scanning direction and the rotation in the forward and reverse directions of the liquid applier 31 and the crimper 32 is not limited to the aforementioned order and may be reversed.

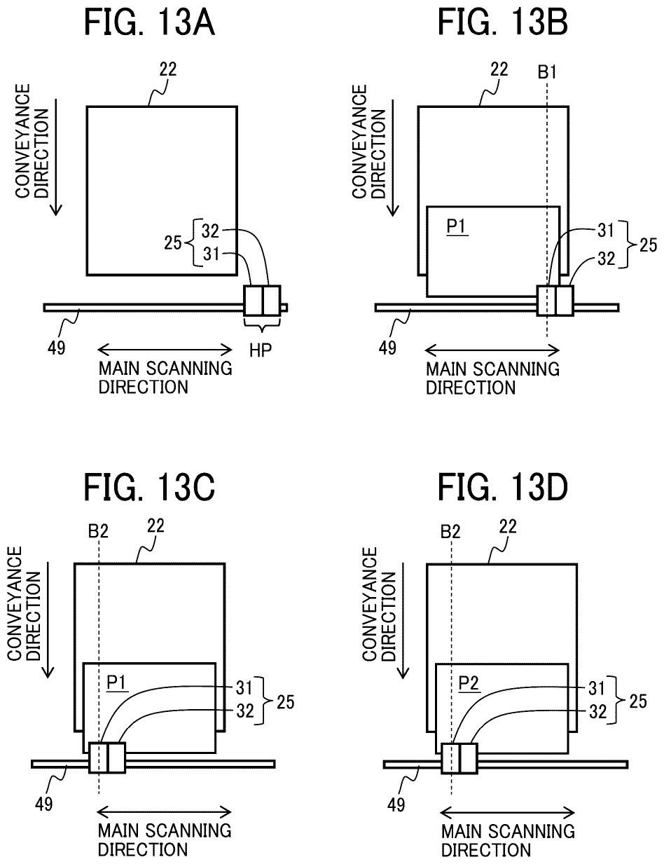

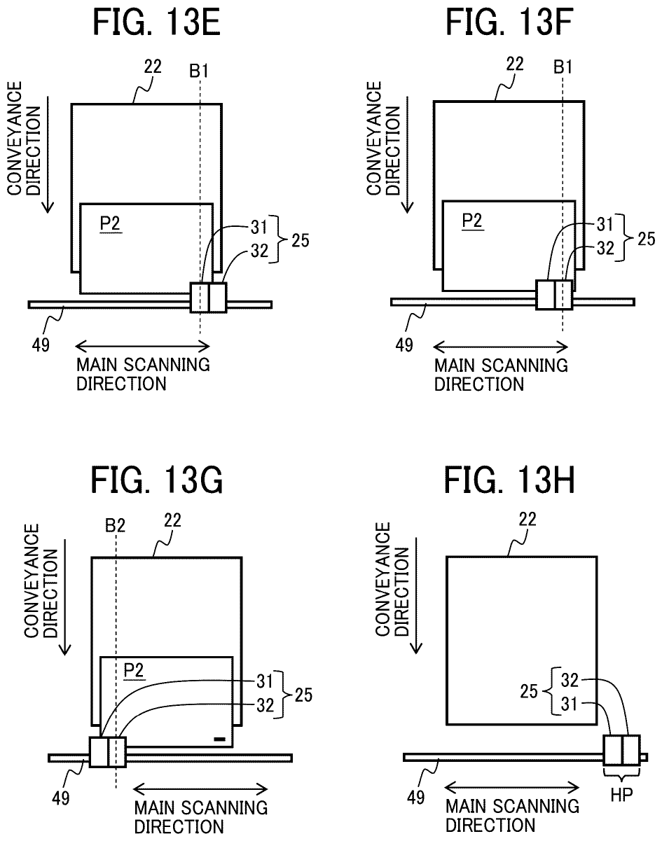

FIGS. 13A, 13B, 13C, 13D, 13E, 13F, 13G, and 13H are diagrams illustrating the positions of the edge binder 25 during the operation of a two-point binding.

A detailed description of points common to the process described with reference to FIGS. 12A to 12D may be omitted, and differences will be mainly described.

As illustrated in FIG. 13A, it is assumed that the edge binder 25 is located at the standby position HP at the start point of the two-point binding. Further, the first binding position B1 and the second binding position B2 are apart from each other in the main scanning direction. In FIGS. 13A to 13H, the case where two sheets P1 and P2 are crimped and bound (in other words, the given number of sheets N=2) will be described. However, the number of sheets P of the sheet bundle Pb is not limited to two.

Before the first sheet P1 of the sheet bundle Pb is placed on the internal tray 22, the controller 100b moves the edge binder 25 in the main scanning direction so that the liquid applier 31 can face the first liquid application position B1. Subsequently, as illustrated in FIG. 13B, the controller 100b places the liquid applier 31 at the position to face the first liquid application position B1. With this state, the sheet P1 on which an image has been formed by the image forming apparatus 2 is placed on the internal tray 22, and the controller 100b moves the side fences 24L and 24R in the main scanning direction to jog the sheets.

Subsequently, with the first sheet P1 being placed on the internal tray 22, the controller 100b causes the liquid applier 31 to apply the liquid at the first liquid application position B1 of the first sheet P1. Then, as illustrated in FIG. 13C, the controller 100b causes the edge binder 25 to move in the main scanning direction so that the liquid applier 31 faces the second liquid application position B2 of the first sheet P1. Subsequently, the controller 100b causes the liquid applier 31 to apply the liquid at the second liquid application position B2 of the first sheet P1.

In response to completion of liquid application to the first liquid application position B1 and the second liquid application position B2 of the first sheet P1 by the liquid applier 31, the controller 100b stores the second sheet P2 constituting the sheet bundle Pb in the internal tray 22 and moves the side fences 24L and 24R in the main scanning direction in a state where the liquid applier 31 is arranged at a position that can face the second liquid application position B2 as illustrated in FIG. 13D, thereby executing the jogging process.

Subsequently, with the second sheet P2 being placed on the internal tray 22, the controller 100b causes the liquid applier 31 to apply the liquid at the second liquid application position B2 of the second sheet P2. Then, as illustrated in FIG. 13E, the controller 100b causes the edge binder 25 to move in the main scanning direction so that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeat the conveyance of the sheet P and the liquid application to the first liquid application position B1 and the second liquid application position B2 until the number of sheets P placed on the internal tray 22 reaches the given number of sheets N. At this time, the controller 100b controls the liquid applier 31 to apply the liquid to the B-th sheet P (B<N) in the order of the first liquid application position B1 and the second liquid application position B2. Subsequently, the controller 100b controls the liquid applier 31 to apply the liquid to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P.

The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, when the controller 100b determines that the number of sheets P placed on the internal tray 22 has reached the given number of sheets N, the controller 100b causes the edge binder 25 to move in the main scanning direction so that the crimper 32 faces the first binding position B1 as illustrated in FIG. 13F. The controller 100b causes the crimper 32 to crimp and bind the first binding position B1 of the sheet bundle Pb including the first sheet P1 and the second sheet P2 placed on the internal tray 22. Then, as illustrated in FIG. 13G, the controller 100b causes the edge binder 25 to move in the main scanning direction so that the crimper 32 faces the second binding position B2 of the sheet bundle Pb. The controller 100b causes the crimper 32 to crimp and bind the second binding position B2 of the sheet bundle Pb placed on the internal tray 22.

In the example illustrated in FIGS. 13A to 13H, since the controller 100b causes the liquid applier 31 to finally apply the liquid to the first liquid application position B1, the crimper 32 performs the crimp binding processes in the order of the first binding position B1 and the second binding position B2. On the other hand, when the controller 100b causes the liquid applier 31 to finally apply the liquid to the second liquid application position B2, the crimper 32 performs the crimp binding processes in the order of the second binding position B2 and the first binding position B1.

In other words, as illustrated in FIG. 13, the controller 100b causes the edge binder movement assembly 57 to move the edge binder 25 by the shortest distance between the position at which the liquid applier 31 faces the first liquid application position B1 and the position at which the liquid applier 31 faces the second liquid application position B2 without passing through the standby position HP. The controller 100b causes the edge binder movement assembly 57 to move the edge binder 25 by the shortest distance between the position at which the crimper 32 faces the first binding position B1 and the position at which the crimper 32 faces the second binding position B2 without passing through the standby position HP. Further, the controller 100b causes the edge binder movement assembly 57 to move the edge binder 25 by the shortest distance between the position at which the liquid applier 31 faces the first liquid application position B1 (or the second liquid application position B2) and the position at which the crimper 32 faces the first binding position B1 (or the second binding position B2) without passing through the standby position HP.

Then, the controller 100b causes the conveyance roller pair 15 to rotate to eject the sheet bundle Pb to the second ejection tray 26 after the sheet bundle Pb is crimped and bound by the crimper 32 at the first binding position B1 and the second binding position B2. Furthermore, as illustrated in FIG. 13H, the controller 100b drives the edge binder movement motor 55 to move the edge binder 25 (the liquid applier 31 and the crimper 32) to the standby position HP.

### Detailed Description of Liquid Applying Assembly

The liquid applying assembly 36 included in the post-processing apparatus 3 according to the present invention will be described in more detail.

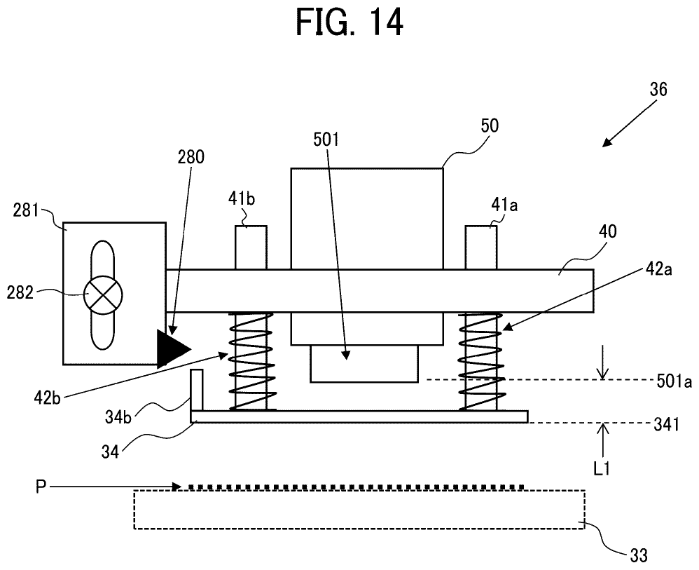

FIG. 14 illustrates only the liquid applying assembly 36, and illustrates a “standby state” in which a sheet P to be applied with liquid is placed between the lower pressure plate 33 and the upper pressure plate 34 and before the liquid applying operation is performed.

In the standby state, in the liquid applying assembly 36, the liquid applying assembly base 40 including the upper pressure plate 34 stands by while holding a given position by the liquid applier movement assembly 35 (see FIG. 3). The lower pressure plate 33 is disposed at a position facing the upper pressure plate 34 and at a lower position in the thickness direction of the sheet P, and the sheet P is placed on the lower pressure plate 33 to receive support when liquid is applied. In other words, the liquid applying assembly 36 is disposed to face the lower pressure plate 33 with the sheet P interposed therebetween.

In the liquid applying assembly 36 in the standby state, the position where the upper pressure plate 34 is held is the maximum separated position with respect to the liquid applying assembly base 40. That is, the separation distance between a pressing surface 341 of the upper pressure plate 34 and a liquid applying surface 501a as a contact surface with which the liquid application member 501 comes into contact with the sheet P to apply the liquid is the “standby distance L1” as illustrated in FIG. 14.

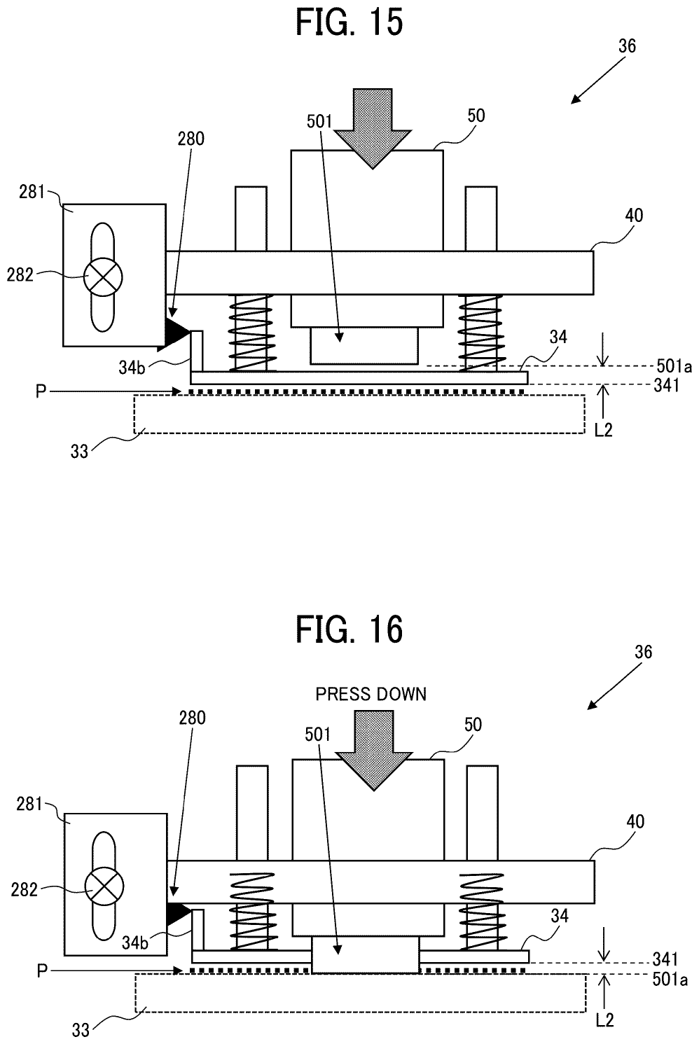

FIG. 15 illustrates a “pressed state” in which the sheet P is pressed by the liquid applying assembly 36.

In the “pressed state”, the upper pressure plate 34 is lowered by the liquid applier movement assembly 35, and the pressing surface 341 of the upper pressure plate 34 presses the sheet P between the lower pressure plates 33, thereby suppressing a gap between the sheets due to curling, waving, or the like of the sheet P. Thus, a stable liquid-applied surface is formed on the sheet P.

When the lowering of the liquid applying assembly base 40 is continued in a state where the liquid-applied surface is formed on the sheet P, the relative separation distance between the upper pressure plate 34 and the liquid applying assembly base 40 is reduced. When the lowering of the upper pressure plate 34 is continued, the distance between the pressing surface 341 and the liquid applying surface 501a of the liquid application member 501 eventually becomes a separation design value L2. By determining detection information of the upper pressure plate position detection sensor 280 in the controller 100b, it is possible to determine whether or not the position of the upper pressure plate 34 has reached the separation design value L2.

When the distance between the pressing surface 341 and the liquid applying surface 501a of the liquid application member 501 reaches the separation design value L2, the upper pressure plate position detection sensor 280 detects the upper pressure plate position detection shutter unit 34b.

Since the liquid application member 501 is made of a material such as sponge and thus has a large variation in dimension, there has been a problem that the distance relationship between the liquid applying surface 501a and the liquid-applied surface is not stable. On the other hand, in the present embodiment, the upper pressure plate position detection sensor mounting bracket 281 to which the upper pressure plate position detection sensor 280 is attached is adjustably held with respect to the liquid applying assembly base 40 so that the separation design value L2 described above is set to a constant value. The upper pressure plate position detection sensor mounting bracket 281 can be adjusted with respect to the liquid applying assembly base 40 by the upper pressure plate position detection sensor adjusting screw 282. That is, the upper pressure plate position detection sensor 280 is held so that the relative position in the vertical direction with respect to the liquid applying assembly base 40 can be adjusted.

FIG. 16 illustrates a “liquid applying state” in which the liquid applying assembly 36 descends and applies liquid to the sheet P.

The amount of liquid (liquid application amount) applied to the sheet P in one liquid application varies depending on a protrusion distance of the liquid applying surface 501a with respect to the pressing surface 341. The larger the protrusion distance, the larger the volume of the liquid application member 501 for crushing the sponge, and thus the liquid application amount also increases. For this reason, the protrusion distance L3 of the liquid applying surface 501a may be controlled by the controller 100b as a set value.

In the control process according to the present embodiment, the distance corresponding to “separation design value L2+protrusion distance L3” is controlled to stop when the liquid applying assembly 36 descends, using the detection information (sensor detection information) of the separation design value L2 that is the distance between the pressing surface 341 and the liquid applying surface 501a of the liquid application member 501 as a trigger. By such control, a suitable liquid application amount can be stably applied to the sheet.

In addition, the liquid application amount increases or decreases depending on the time during which the liquid applying assembly 36 is stopped in the liquid application state. For this reason, the stop time is also controlled. That is, the stop time is determined, and the liquid applying assembly 36 is raised to the standby state (see FIG. 14) and stopped using the stop time as a trigger.

Further, in executing the lifting and lowering operation of the liquid applying assembly 36 by the liquid applier movement assembly 35 (see FIG. 3), the movement amount of the liquid applying assembly 36 in the liquid applier movement assembly 35 is configured to be controlled by the number of pulses notified from the controller 100b.

### Example of Category Table of Medium Information

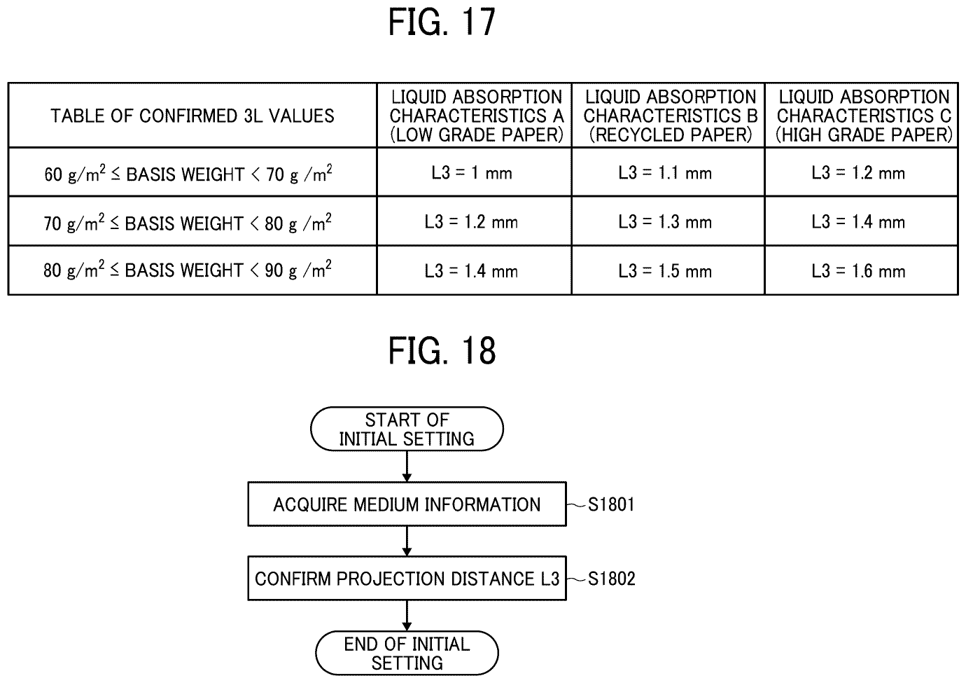

FIG. 17 is an example of table structure data for determining the value of the protrusion distance L3.

The data illustrated in FIG. 17 is, for example, category information divided into a category of the type (medium information) of the sheet P and a category of the thickness (basis weight) of the sheet P. The category information is configured by combining data divided into a plurality of categories and associating values of “protrusion distances L3” in each combination. That is, the category information according to the present embodiment is a data set used to determine the protrusion distance L3.

As illustrated in FIG. 17, in the table structure data of the protrusion distance L3, the type of the medium (sheet P) is distinguished using absorption characteristic information indicating absorbency, such as “absorption characteristic A (low grade paper or additional paper)”, “absorption characteristic B (recycled paper)”, and “absorption characteristic C (high grade paper)”, as information (medium information) regarding the medium. In addition, regarding the thickness (basis weight) of the sheet P, the thickness information is classified into categories such as “60 g/m²≤basis weight <70 g/m²”, “70 g/m²≤basis weight<80 g/m²”, and “80 g/m²≤basis weigh <90 g/m²”. That is, the medium information is stored in a table structure divided into basis weight information indicating the weight of the sheet P, water absorption characteristics different for each sheet P, and categories.

According to the example of FIG. 17, the protrusion distance L3 is set to be small for woody paper or the like having higher water absorption characteristics than high quality paper. Since the paper itself actively absorbs water, the liquid application amount is adjusted by pushing the liquid application member 501 slightly. In addition, in the basis weight, which is weight, the volume naturally increases as the weight increases, and thus, the protrusion distance L3 is set stepwise large for the purpose of applying more liquid.

This embodiment is an embodiment in which the basis weight and the water absorption characteristics are combined, but it is needless to say that the basis weight and the water absorption characteristics may be set for each sheet type information or may be one piece of information. This paper medium information may be input and set by the present device alone, or when input to a connected device that may be connected to the present device, the information is acquired by data transmission to the present apparatus.

### Determination Flowchart of Protrusion Distance L3 of Liquid Applying Surface

An embodiment of control processing executable in the post-processing apparatus 3 according to the present embodiment will be described.

FIG. 18 is a flowchart illustrating an example of a flow of processing for determining the protrusion distance L3 of the liquid applying surface.

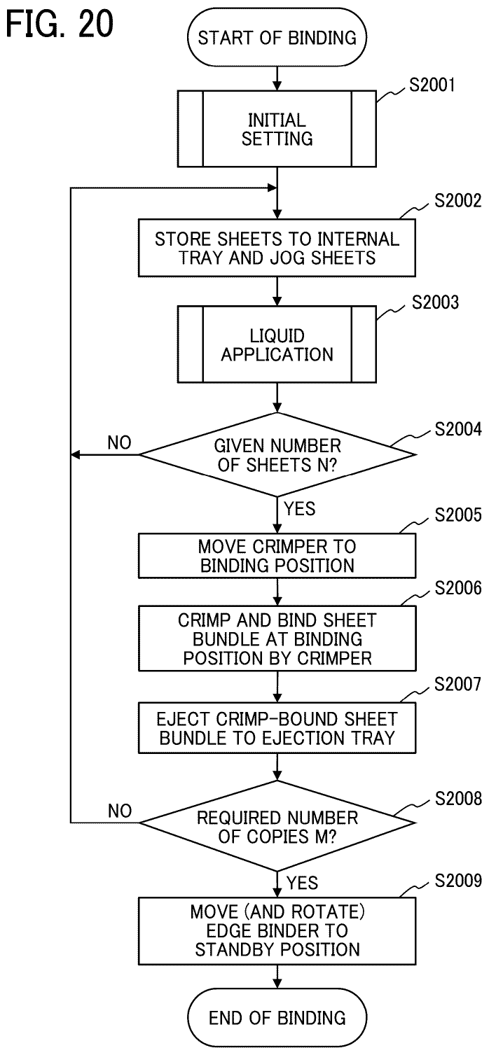

The process illustrated in FIG. 18 corresponds to an “initial setting process (step S2001)” in the flow of the binding process (see FIG. 20) to be described later.

First, when a job including the binding process is started, medium information of a medium (sheet P) to be subjected to the binding process is acquired (step S1801). Subsequently, the medium information is compared with the “L3 value determination table” illustrated in FIG. 17 to determine the value of the protrusion distance L3 (step S1802).

### Flowchart of Liquid Application Process

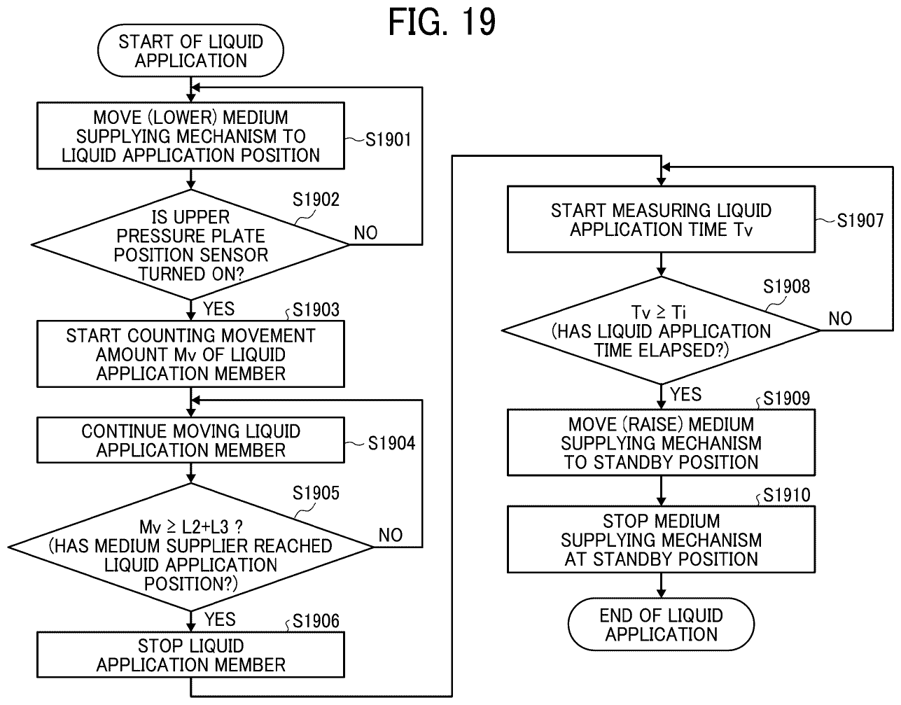

A control flow of the liquid application process executable in the post-processing apparatus 3 according to the present embodiment will be described with reference to FIG. 19. FIG. 19 corresponds to the “liquid application process (step S2003)” in the flow of the binding process (see FIG. 20) described later.

First, the liquid application member 501 is lowered toward the liquid application position by the liquid applier movement assembly 35 (step S1901). The lowering is continued until the distance between the pressing surface 341 and the liquid applying surface 501a of the liquid application member 501 reaches the separation design value L2, that is, until the upper pressure plate position detection sensor 280 detects the upper pressure plate position detection shutter unit 34b (NO in step S1902). The liquid applying assembly base 40 is lowered for the purpose of applying liquid to the sheet P, and presses the sheet P placed on the lower pressure plate 33 with the pressing surface 341 of the upper pressure plate 34. In this state, a gap between the sheets due to curling and waviness of the sheet P is suppressed, and a stable liquid application surface of the sheet P is formed.

When the upper pressure plate position detection sensor 280 detects the upper pressure plate position detection shutter unit 34b (YES in step S1902), counting of the movement amount Mv of the liquid application member 501 is started (step S1903), and lowering of the liquid applying assembly 36 is continued (step S1904). The lowering is continued, and the upper pressure plate 34 is held at the position to shorten the separation distance with respect to the liquid applying assembly base 40 (NO in step S1905). When the movement amount Mv of the pressing surface 341 and the liquid applying surface 501a of the liquid application member 501 becomes the total value of the separation design value L2 and the protrusion distance L3 determined in advance (S1905: YES), the movement is stopped (step S1906).

After the lowering of the liquid applying assembly 36 is stopped, counting of a time (liquid applying time Tv) during which the liquid application member 501 is in contact with the liquid-applied surface is started (step S1907). The process is looped until the liquid applying time Tv becomes equal to or more than the design value Ti (NO in step S1908).

When the liquid applying time Tv becomes equal to or more than the design value Ti (YES in step S1908), the liquid applier movement motor 42 starts to raise the liquid applying assembly 36 (step S1909), and the liquid applying assembly 36 is stopped at the standby position (step S1910).

### Flowchart of Binding Processing

An example of a flow of binding processing executed in the post-processing apparatus 3 according to the present embodiment will be described with reference to a flowchart of FIG. 20. Although processing similar to the binding processing described with reference to FIG. 11 is already included, processing specific to the present embodiment is also included, and thus a series of flows will be described.

First, an initial setting process is executed (step S2001). The process of step S2001 is a process of determining the protrusion distance L3 described with reference to FIG. 18.

Then, the controller 100b rotates the conveyance roller pairs 10, 11, 14, and 15 to stack the sheet P on which an image has been formed by the image forming apparatus 2 on the internal tray 22. The controller 100 aligns the position in the main scanning direction of the sheet P supported by the internal tray 22 by moving the side fences 24L and 24R (so-called jogging) (step S2002).

Subsequently, a liquid application process is executed (step S2003). Step S2003 is the processing described with reference to FIG. 19.

It is determined whether or not the number of sheets P placed on the internal tray 22 has reached the given number of sheets N instructed by the binding command (step S2004). Then, in a case where it is determined that the number of sheets P stacked on the internal tray 22 has not reached the given number of sheets N (NO in step S2004), the controller 100b executes the process of steps S2002 and S2003 again.

When it is determined that the number of sheets P placed in the internal tray 22 has reached the given number (YES in step S2004), the controller 100 drives the edge binder movement motor 55 to move the edge binder 25 in the main scanning direction so that the crimper 32 faces the binding position (step S2005). Subsequently, the sheet bundle Pb placed on the internal tray 22 is subjected to crimp binding (step S2006), and discharged to the second ejection tray 26 (step S2007). That is, the controller 100b drives the contact-separation motor 32d to cause the upper crimping teeth 32a to sandwich the binding position of the sheet bundle Pb stacked on the internal tray 22 with the lower crimping teeth 32b. At this time, depending on conditions, the controller 100b drives a crimping teeth slide motor to perform the crimp binding process a plurality of times so that the crimping marks are adjacent. Thereafter, the controller 100b rotates the conveyance roller pair 15 to eject the crimped and bound sheet bundle Pb to the second ejection tray 26.

Subsequently, it is determined whether or not the number of the ejected sheet bundles Pb has reached the requested number of copies indicated by the binding command (step S2008). In a case where it is determined that the number of the ejected sheet bundles Pb has not reached the requested number of copies (NO in step S2008), the controller 100 executes the processing of steps S2002 and the following steps again. That is, the operations of steps S2002 to S2008 are performed until the number of sheet bundles Pb output to the second ejection tray 26 reaches the requested number of copies.

When the number of copies of the sheet bundle Pb reaches the required number of copies (YES in step S2008), the edge binder movement motor 55 is driven to move the edge binder 25 to the standby position. When the posture that is instructed by the binding command is the “inclined binding posture”, the crimper pivot motor 56 is also driven to rotate the liquid applier 31 and the crimper 32 into the parallel binding posture. In contrast, when the posture that is instructed by the binding command is the “parallel binding posture”, the controller 100 omits the aforementioned operation. As a result, the liquid applier 31 and the crimper 32 return to the original positions (step S2009).

With the post-processing apparatus 3 according to the present embodiment described above, the liquid-applied surface of the sheet P is pressed and adjusted, and the distance to the liquid application position can be determined in a state where the liquid applying surface of the liquid application member 501 is stable. In addition, a stable liquid application amount can be accurately controlled regardless of the type, the number, and the like of the medium.

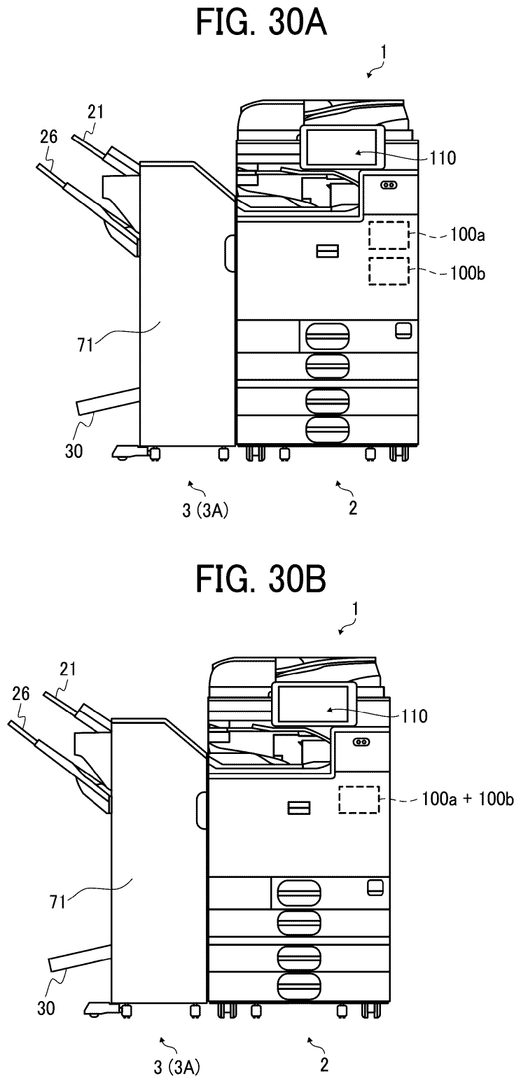

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 30A, the controller 100b of the post-processing apparatus 3 may be disposed in the image forming apparatus 2. Further, as illustrated in FIG. 30B, the controller 100b of the post-processing apparatus 3 may be integrated with the controller 100a of the image forming apparatus 2.

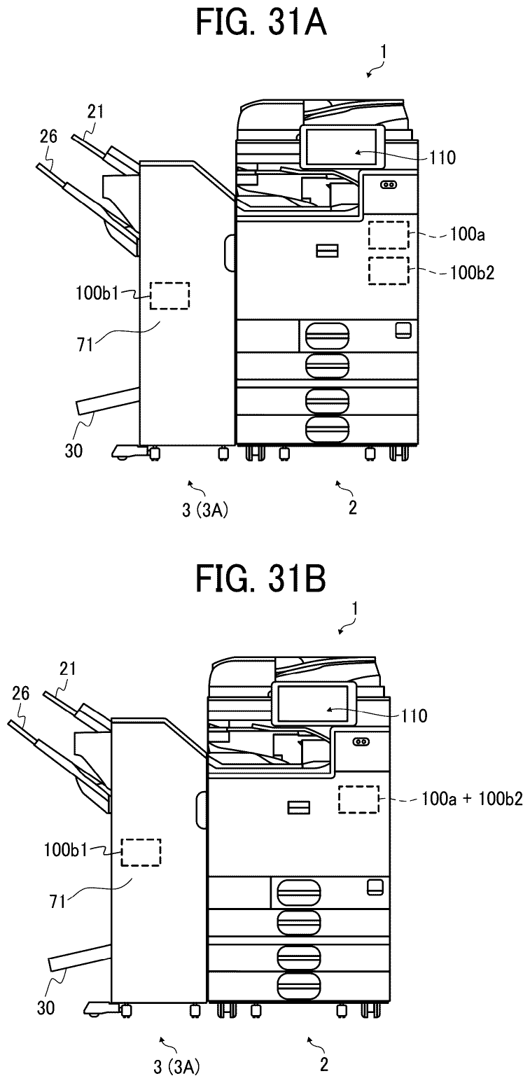

As illustrated in FIG. 31A, the controller 100b of the post-processing apparatus 3 may be divided into a controller 100b1 (e.g., a drive unit such as a motor) and a controller 100b2 (detector such as a sensor) according to the function, and only the controller 100b2 of the post-processing apparatus 3 may be disposed on the side of the image forming apparatus 2. Further, as illustrated in FIG. 31B, the controller 100b2 of the post-processing apparatus 3 disposed on the side of the image forming apparatus 2 may be integrated with the controller 100a of the image forming apparatus 2.

### Second Embodiment of Post-Processing Apparatus

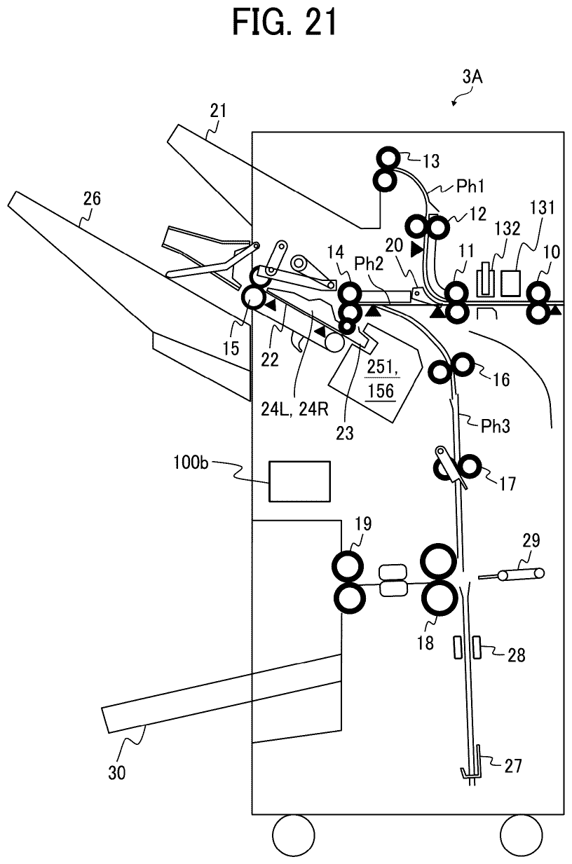

A post-processing apparatus 3A according to the second embodiment will be described with reference to FIGS. 21 to 29. In the following description, components like those of the post-processing apparatus 3 according to the first embodiment are denoted by like reference numerals, and redundant descriptions thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is disposed on the upstream side of a conveyance passage. Such a configuration allows a given number of sheets P to be stacked after the liquid application process and conveyed to the crimper 32′ of the edge binder 251 disposed on the downstream side, and thus productivity of the binding process performed by the crimper 32′ is enhanced. Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P is defined as the “main scanning direction” or the “width direction of the sheet P”. The liquid application position to which liquid is applied on a sheet P or a sheet bundle Pb by the liquid applier 131 corresponds to the binding position on the sheet bundle Pb to be crimped by the crimper 32′. For this reason, in the following description, the liquid application position and the binding position are denoted by the same reference sign (B1).

FIG. 21 is a diagram illustrating an internal structure of the post-processing apparatus 3A according to the second embodiment of the present disclosure.

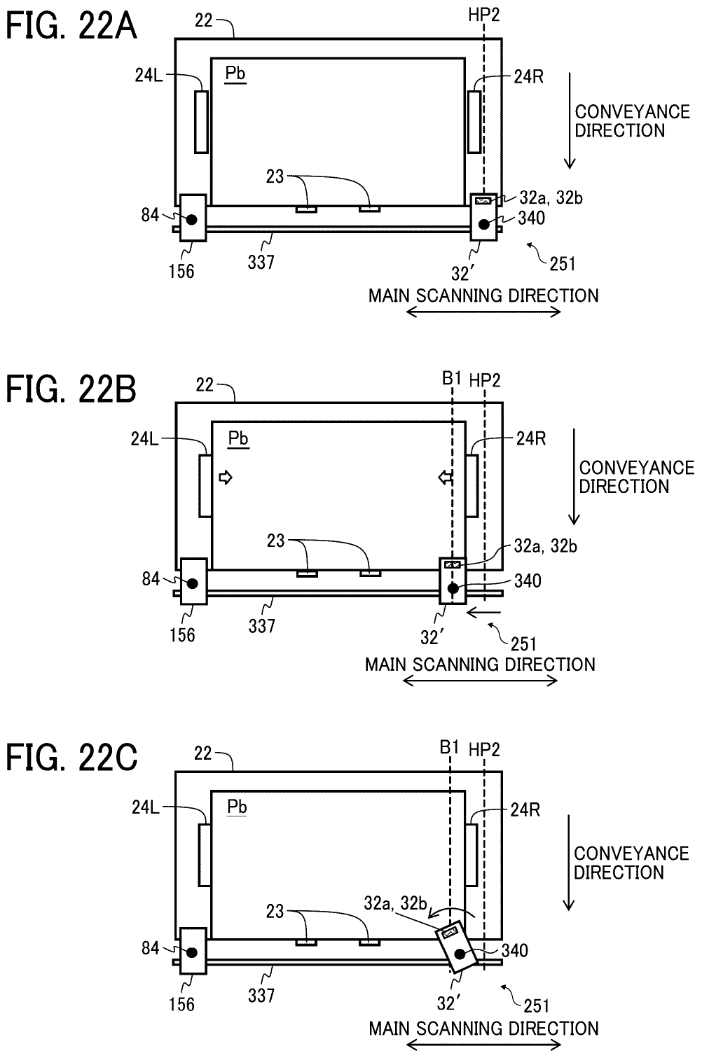

As illustrated in FIGS. 22A, 22B, and 22C, the edge binder 251 includes only the crimper 32′. As illustrated in FIG. 22, the crimper 32′ and a staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

The crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, a desired position in the main scanning direction on the sheet bundle Pb placed on the internal tray 22 as in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb (referred to as “crimping” below). On the other hand, the staple binder 156 passes the staple through a binding position on the sheet bundle Pb placed on the internal tray 22 to staple the sheet bundle Pb.

FIGS. 22A, 22B, and 22C are schematic views of the internal tray 22 as viewed from the thickness direction of the sheet bundle Pb.

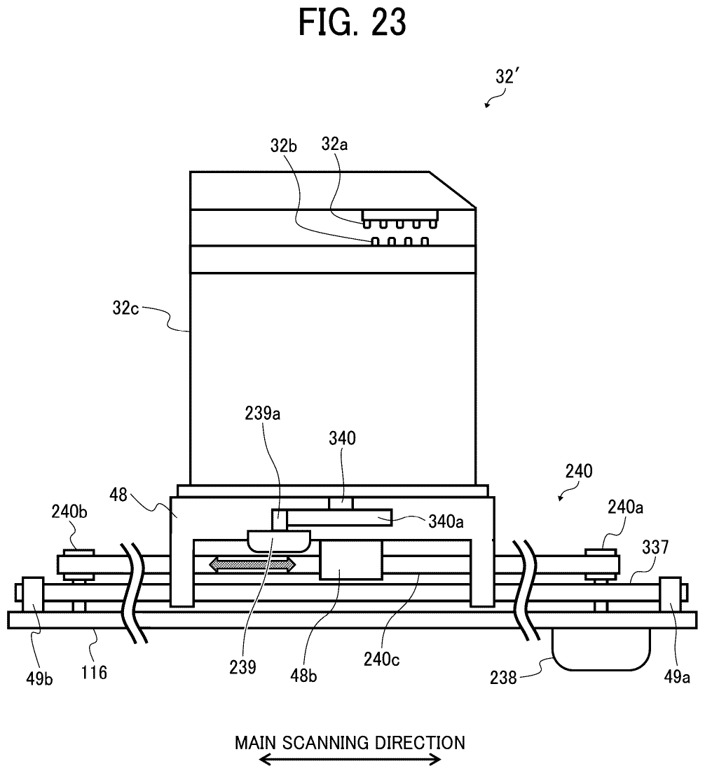

FIG. 23 is a schematic view of the crimper 32′ as viewed from the conveyance direction.

As illustrated in FIG. 22, the crimper 32′ and the staple binder 156 are disposed downstream from the internal tray 22 in the conveyance direction. The crimper 32′ is movable in the main scanning direction along the surface of the sheet bundle Pb placed on the internal tray 22. The crimper 32′ is configured to be rotatable in the forward and reverse directions about a crimper shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in thickness direction of the sheet bundle Pb. The other components of the staple binder 156 are similar to, even if not the same as, those of the staple binder 155 (see FIG. 6) of the post-processing apparatus 3 according to the first embodiment. For this reason, a detailed description thereof is omitted.

As illustrated in FIG. 23, the crimper 32′ includes a guide rail 337 extending in the main scanning direction at a position downstream from the internal tray 22 in the conveyance direction. The crimper 32′ includes a crimper moving motor 238 as a driving source. The base 48 supporting the crimping frame 32c has a fastening portion 48b for fastening a timing belt 240c at the bottom of the base 48. The driving force of the crimper moving motor 238 is transmitted to the base 48 by a drive transmission assembly 240 that includes pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper shaft 340 including a drive transmission gear 340a is fixed to a bottom face of the crimping frame 32c that holds the components of the crimper 32′.

The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper moving motor 238, the crimper pivot motor 239, the crimper shaft 340, and the drive transmission assembly 240 constitute at least part of a driving assembly of the crimper 32′ according to the present embodiment.

The crimper 32′ is movable between a standby position HP2 illustrated in FIG. 22A and a position where the crimper 32′ faces the first binding position B1 illustrated in FIGS.

22B and 22C. The standby position HP2 is a position deviated to one side in the main scanning direction from the sheet bundle Pb stacked on the internal tray 22. The first binding position B1 is a position on the sheet bundle Pb placed on the internal tray 22. The specific position of the first binding position B1 is not limited to the example of FIGS. 22A to 22C, and may be any position in the main scanning direction at the downstream end in the conveyance direction of the sheet P, and may be a plurality of positions.

The posture of the crimper 32′ changes or is pivoted between a parallel binding posture illustrated in FIG. 22B and an inclined binding posture illustrated in FIG. 22C. In other words, the crimper 32′ is rotatable in the forward and reverse directions about the crimper shaft 340. The parallel binding posture is a posture of the crimper 32′ in which the longitudinal direction of the upper crimping teeth 32a and the lower crimping teeth 32b (in other words, a rectangular crimp binding trace) is along the main scanning direction. The inclined binding posture is a posture of the crimper 32′ in which the longitudinal direction of the upper crimping teeth 32a and the lower crimping teeth 32b (in other words, a rectangular crimp binding trace) is inclined with respect to the main scanning direction.

The rotational angle, which is an angle of the upper crimping teeth 32a and the lower crimping teeth 32b with respect to the main scanning direction, in the inclined binding posture is not limited to the angle illustrated in FIG. 22C. The rotational angle in the inclined binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19.

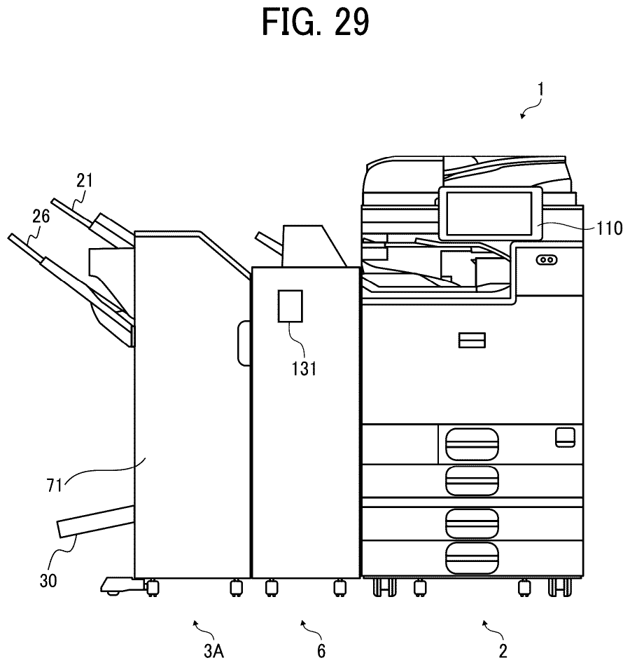

The liquid applier 131 and the hole punch 132 according to the present embodiment are disposed between the conveyance roller pairs 10 and 11. However, the arrangement of the liquid applier 131 is not limited to the example of FIG. 21. For example, in a case where an inserter 6 is disposed between the image forming apparatus 2 and the post-processing apparatus 3A as illustrated in FIG. 29, the liquid applier 131 may be disposed inside the inserter 6 located upstream from the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

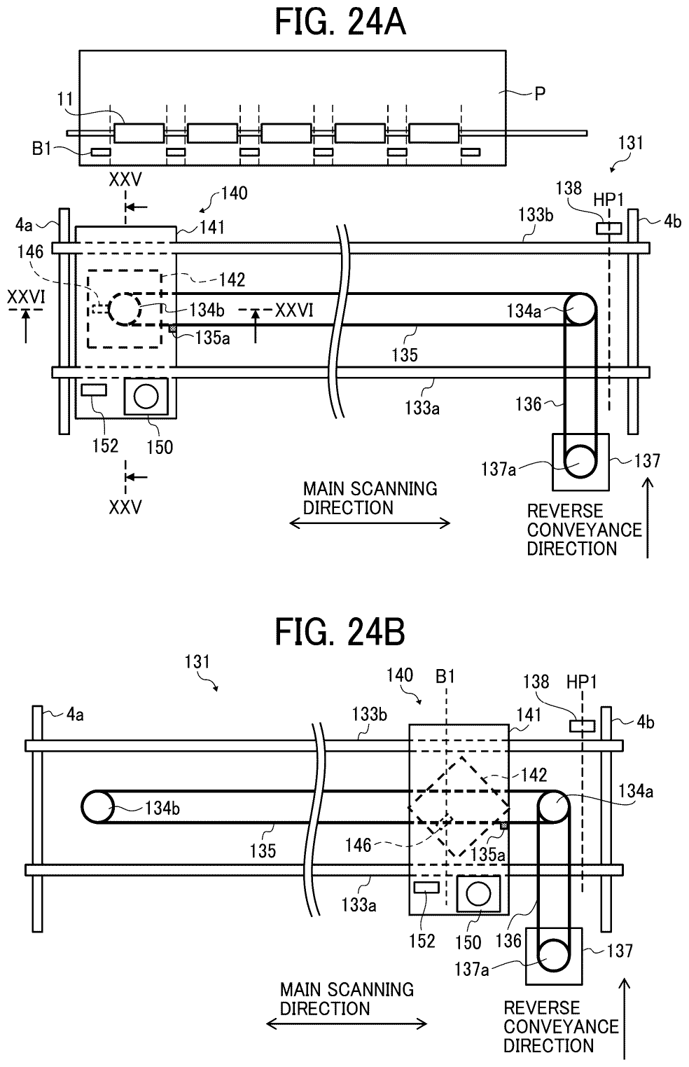

As illustrated in FIG. 24A, the conveyance roller pair 11 is located so as not to overlap, in the main scanning direction, the first liquid application position B1 on the sheet P to which the liquid has been applied by a liquid application head 146 of the liquid applier 131. This arrangement is to prevent the amount of liquid at the first liquid application position B1 from decreasing due to the multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

Furthermore, by arranging the plurality of roller pairs of the conveyance roller pair 11 at positions not overlapping, in the main scanning direction, the first liquid application position B1 of the sheet P, deterioration of the conveying performance of the sheet P due to adhesion of liquid to the plurality of roller pairs and a conveyance jam caused by deterioration of the conveyability can be both prevented.

Although only the conveyance roller pair 11 has been described above, the multiple roller pairs of the conveyance roller pairs 14 and 15 are preferably located so as not to overlap the first liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application”. The hole punch 132 punches a hole in the sheet P that is conveyed by the conveyance roller pairs 10 and 11 so that the hole passes through the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

FIGS. 24A and 24B are views of the liquid applier 131 in the thickness direction of the sheet P, according to the second embodiment of the present disclosure.

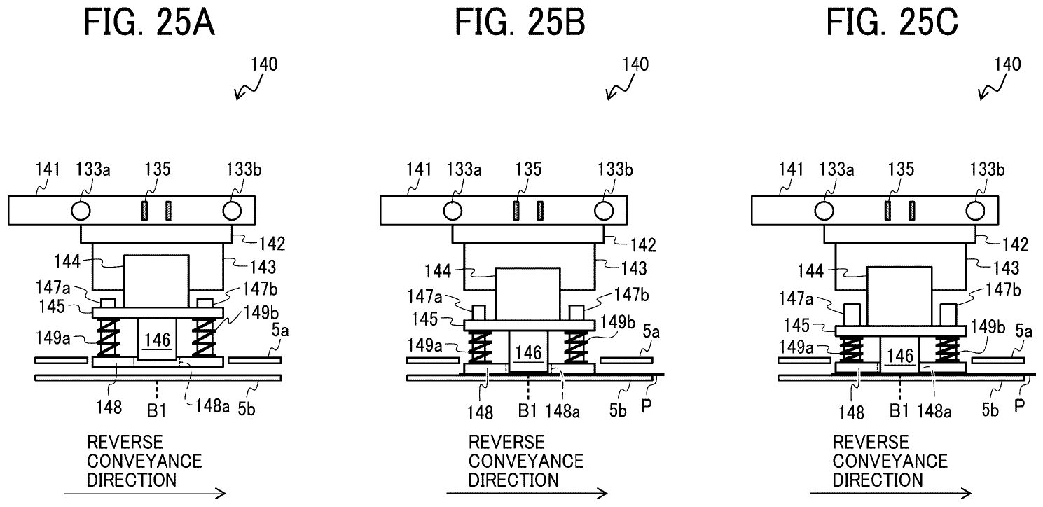

FIGS. 25A, 25B, and 25C are cross-sectional views of the liquid applier 131 taken along line XXV-XXV of FIG. 24A.

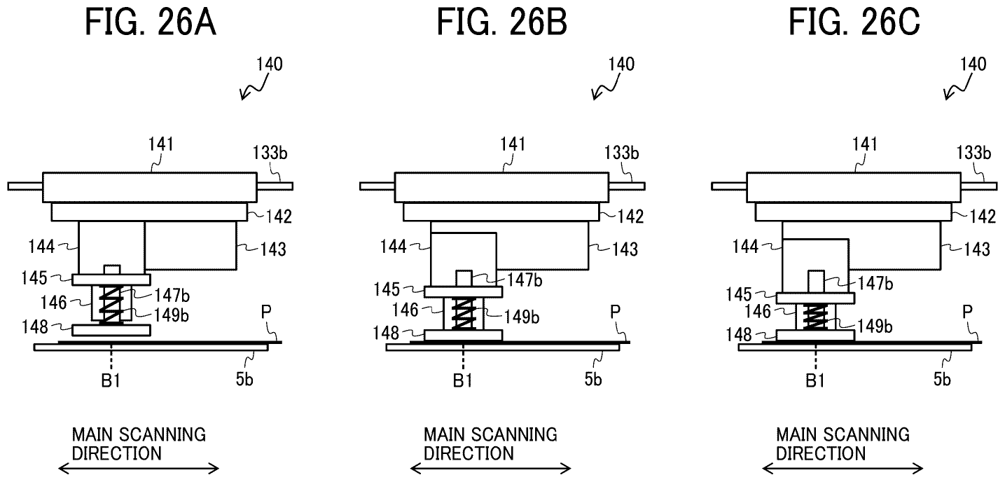

FIGS. 26A, 26B, and 26C are cross-sectional views of the liquid applier 131 taken along line XXVI-XXVI of FIG. 24A.

As illustrated in FIGS. 24A to 26C, the liquid applier 131 includes a pair of guide shafts 133a and 133b, a pair of pulleys 134a and 134b, endless annular belts 135 and 136, a liquid applier moving motor 137, a standby position sensor 138, and a liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 so that the liquid application unit 140 can move in the main scanning direction. The pair of pulleys 134a and 134b are disposed between the pair of guide shafts 133a and 133b in the opposite conveyance direction. The pair of pulleys 134a and 134b is spaced apart from each other in the main scanning direction. The pair of pulleys 134a and 134b are supported by a frame of the post-processing apparatus 3A so as to be rotatable in the forward and reverse directions about the respective shafts extending in the thickness direction of the sheet P. The endless annular belt 135 is looped around the pair of pulleys 134a and 134b. The endless annular belt 135 is coupled to the liquid application unit 140 by a coupling portion 135a. The endless annular belt 136 is entrained around the pulley 134a and a driving pulley 137a that is fixed to an output shaft of the liquid applier moving motor 137. The liquid applier moving motor 137 generates a driving force to move the liquid application unit 140 in the main scanning direction.

As the liquid applier moving motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to switching of the rotation direction of the liquid applier moving motor 137.

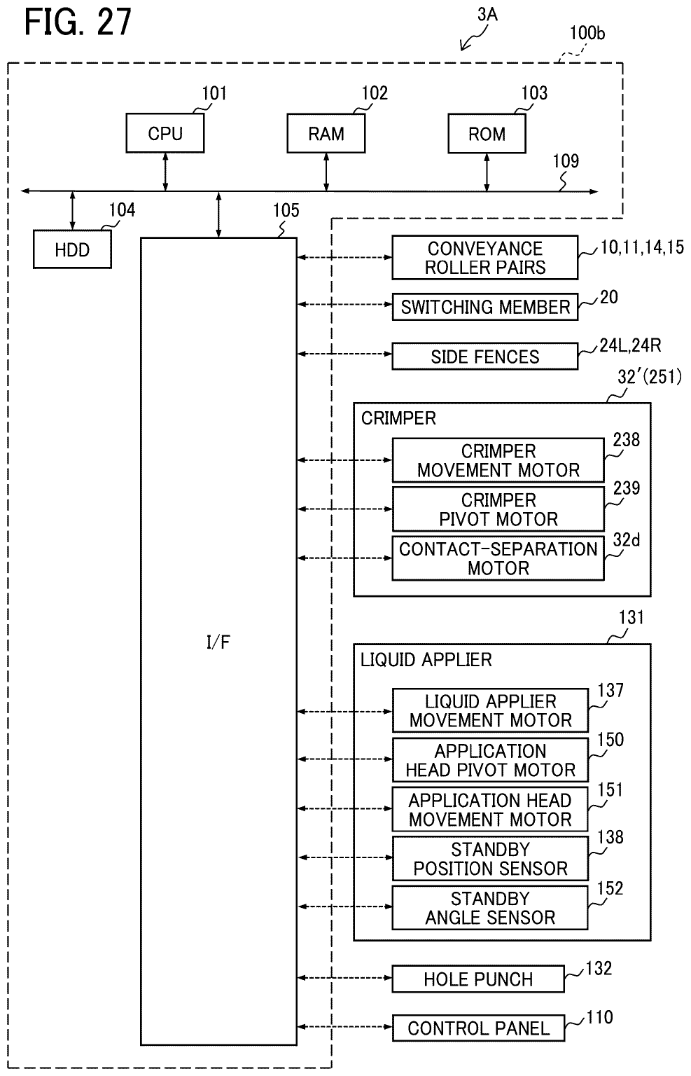

The standby position sensor 138 detects that the liquid application unit 140 has reached a standby position HP1 in the main scanning direction (see FIGS. 24A and 24B), and outputs a standby position signal indicating a detection result to a controller 100b to be described later (see FIG. 27). The standby position sensor 138 is, for example, an optical sensor including a light emitter and a light receiver. At the standby position HP1, the liquid application unit 140 blocks the optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 25A, 25B, and 25C, the conveyance passage inside the post-processing apparatus 3A is defined by an upper guide plate 5a and a lower guide plate 5b, which are spaced apart from each other in the thickness direction of the sheet P. The liquid application unit 140 is located at a position to face an opening of the upper guide plate 5a. In other words, the liquid application unit 140 is disposed to face the conveyance passage (a position at which the liquid application unit 140 is to face the sheet P conveyed along the conveyance passage) through the opening of the upper guide plate 5a.

As illustrated in FIGS. 24A to 26C, the liquid application unit 140 includes a base 141, a rotary bracket 142, a liquid storage tank 143, an application head mover 144, a holder 145, the liquid application head 146, columns 147a and 147b, a pressure plate 148, coil springs 149a and 149b, an application head pivot motor 150, an application head moving motor 151 (see FIG. 27), and a standby angle sensor 152 (see FIG. 27).

The base 141 is supported by the pair of guide shafts 133a and 133b so as to be slidable in the main scanning direction. The base 141 is coupled to the endless annular belt 135 by the coupling portion 135a. The base 141 supports the components (from the rotary bracket 142 to the standby angle sensor 152) of the liquid application unit 140.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application head pivot motor 150. The rotary bracket 142 retains the liquid storage tank 143, the application head mover 144, the holder 145, the liquid application head 146, the columns 147a and 147b, the pressure plate 148, and the coil springs 149a and 149b.

The standby angle sensor 152 (see FIG. 27) detects that the rotary bracket 142 has reached a standby angle, and then outputs a standby angle signal indicating the detection result to the controller 100b. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 24A illustrates the rotary bracket 142 in a position for the parallel binding that is performed by the crimper 32′ disposed downstream from the liquid applier 131 in a direction in which the sheet P is conveyed. FIG. 24B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The application head mover 144 is attached by the liquid storage tank 143 so as to be movable (e.g., up and down) in the thickness direction of the sheet P. The application head mover 144 is moved with respect to the liquid storage tank 143 by a driving force transmitted from the application head moving motor 151. The holder 145 is attached to a lower end of the application head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 in a direction away from the holder 145.

As illustrated in FIGS. 25A and 26A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application head moving motor 151 is rotated in a first direction. As a result, the application head mover 144, the holder 145, the liquid application head 146, the columns 147a and 147b, the pressure plate 148, and the coil springs 149a and 149b are moved down together to allow the pressure plate 148 to contact the sheet P. The first liquid application position B1 corresponds to the first binding position B1 to be crimped and bound by the edge binder 251, specifically, the crimper 32′.

As the application head moving motor 151 keeps rotating in the first direction after the pressure plate 148 contacts the sheet P, the coil springs 149a and 149b are compressed to further move down the application head mover 144, the holder 145, the liquid application head 146, and the columns 147a and 147b. As illustrated in FIGS. 25B and 26B, a lower face of the liquid application head 146 contacts the sheet P through the through hole 148a. As a result, the liquid contained in the liquid application head 146 is applied to the sheet P.

Further rotation of the application head moving motor 151 in the first direction further strongly presses the liquid application head 146 against the sheet P as illustrated in FIGS. 25C and 26C. Accordingly, the amount of liquid that is applied to the sheet P increases. In other words, the liquid applier 131 changes the pressing force of the liquid application head 146 against the sheet P to adjust the amount of liquid that is applied to the sheet P.

On the other hand, the rotation of the application head moving motor 151 in the second direction opposite to the first direction moves up the application head mover 144, the holder 145, the liquid application head 146, the columns 147a and 147b, the pressure plate 148, and the coil springs 149a and 149b together. As a result, as illustrated in FIGS. 25A and 26A, the liquid application head 146 and the pressure plate 148 are separated from the sheet P. In other words, the liquid applier 131 includes the liquid application head 146 that can be separated from the sheet P.

FIG. 27 is a hardware configuration diagram of a control block to control the operation of the post-processing apparatus 3A according to the second embodiment.

As illustrated in FIG. 27, the post-processing apparatus 3A includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3A. The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of a controller 100b (control unit) serving as a control device that controls the operation of the post-processing apparatus 3A.

The I/F 105 is an interface that connects the conveyance roller pairs 10, 11, 14, and 15, the switching member 20, the side fences 24L and 24R, the crimper moving motor 238, the crimper pivot motor 239, the contact-separation motor 32d, the liquid applier moving motor 137, the application head pivot motor 150, the application head moving motor 151, the standby position sensor 138, the standby angle sensor 152, the hole punch 132, and the control panel 110 to the common bus 109.

The controller 100b controls, via the I/F 105, the operations of the conveyance roller pairs 10, 11, 14, and 15, the switching member 20, the side fences 24L and 24R, the crimper moving motor 238, the crimper pivot motor 239, the contact-separation motor 32d, the liquid applier moving motor 137, the application head pivot motor 150, the application head moving motor 151, and the hole punch 132. The controller 100b acquires detection results from the standby position sensor 138 and the standby angle sensor 152 through the I/F 105.

Although FIG. 27 illustrates the components of the liquid applier 131 and the edge binder 251 (the crimper 32′) that executes the edge binding, the components of the saddle binder 28 that executes the saddle binding process are controlled by the controller 100b like the components of the liquid applier 131 and the edge binder 251 (the crimper 32′) that executes the edge binding.

As illustrated in FIG. 29, the image forming apparatus 2 includes the control panel 110. The control panel 110 includes an operation unit that receives instructions input by a user and a display serving as a notifier that notifies the user of information. The operation unit includes, for example, physical input buttons and a touch screen overlaid on a display. The control panel 110 acquires information from the user through the operation unit and provides the information to the user through the display. The post-processing apparatus 3A may include the control panel 110 similar to the above-described control panel 110 of the image forming apparatus 2.

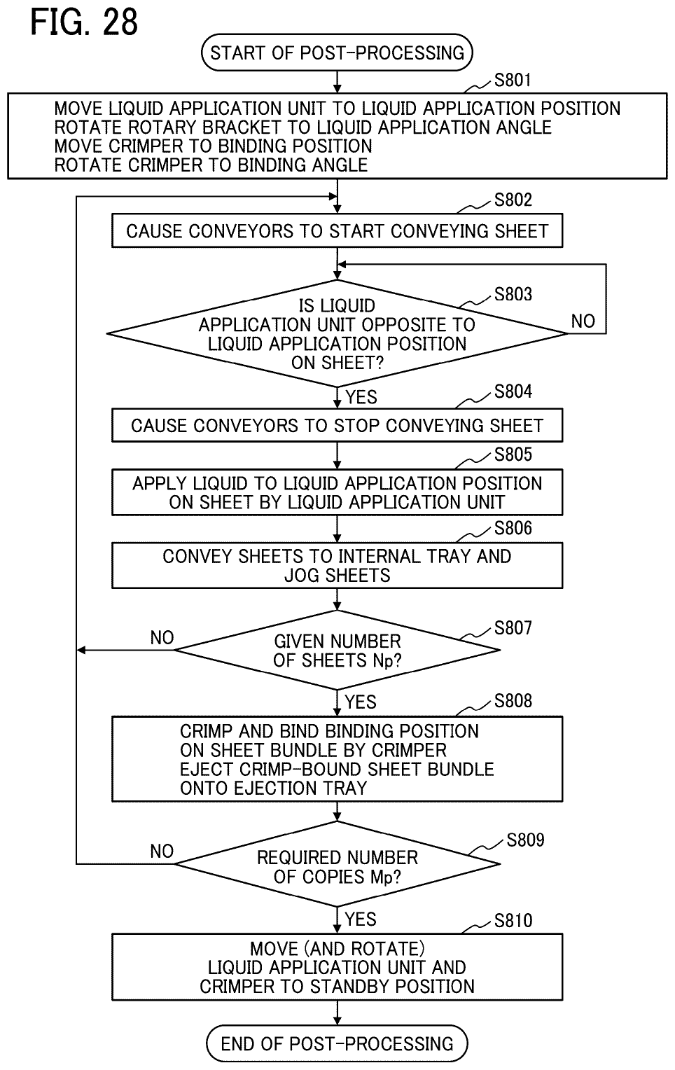

FIG. 28 is a flowchart of post-processing performed by the post-processing apparatus 3A according to the second embodiment.

Specifically, FIG. 28 is a flowchart in executing the one-point binding illustrated in FIG. 22.

For example, the controller 100b executes the post-processing illustrated in FIG. 28 when the controller 100b acquires an instruction to execute the post-processing from the image forming apparatus 2. In the following description, the instruction to execute the post-processing may be referred to as a “post-processing command”. The post-processing command includes, for example, the number of sheets P of the sheet bundle Pb (referred to as “given number of sheets Np”), the number of copies of the sheet bundle Pb on which the binding process is to be executed (referred to as “requested number of copies Mp”), the first binding position B1 (corresponding to the first liquid application position B1), the angle of the first binding position B1 (corresponding to the angle of the first liquid application position B1), the type of the binding process (parallel binding process and inclined binding process), and the process (in the present embodiment, drilling a punch hole) executed in parallel with the liquid application process. At the start of the post-processing, the liquid application unit 140 is located at the standby position HP1 (see FIGS. 24A and 24B), and the rotary bracket 142 is held at a standby angle (corresponding to a “parallel binding posture”).

First, the controller 100b drives the liquid applier moving motor 137 to move the liquid application unit 140 (corresponding to the liquid applier) in the main scanning direction, so that the liquid application head 146 moves from the standby position HP1 to a position where the liquid application head 146 faces the first liquid application position B1 (see FIG. 24B, and corresponding to the first binding position B1 illustrated in FIGS. 22B and 22C). In a case where the type of the binding process instructed by the post-processing command is “oblique binding process”, in step S801, the controller 100b drives the application head pivot motor 150 to rotate the rotary bracket 142. Thus, the liquid application head 146 is rotated from the standby angle to the liquid application angle corresponding to the “inclined binding posture”. It is ascertained based on a pulse signal output from a rotary encoder of the liquid applier moving motor 137 that the liquid application head 146 has reached the position where the liquid application head 146 can face the first liquid application position B1. Similarly, it is ascertained based on a pulse signal output from a rotary encoder of the application head pivot motor 150 that the liquid application head 146 has reached the liquid application angle. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, the controller 100b drives the crimper moving motor 238 to move the crimper 32′ from the standby position HP2 to the position where the crimper 32′ can face the first binding position B1 as illustrated in FIGS. 22A and 22B (step S801). Alternatively, in a case where the type of the binding process instructed by the post-processing command is “inclined binding process”, the controller 100b drives the crimper pivot motor 239 to rotate the crimper 32′ from the standby angle to the crimping angle corresponding to the “inclined binding posture” (step S801). The position at which the crimper 32′ faces the first binding position B1 and the crimper 32′ reaching the crimp binding angle can be ascertained from pulse signals output from the rotary encoders of the crimper moving motor 238 and the crimper pivot motor 239. If the type of the binding process instructed by the post-processing command is “parallel binding process”, the controller 100b omits the above-described operation of rotating the crimper 32′. In other words, the crimper 32′ moves in the main scanning direction while maintaining the standby angle.

Subsequently, the controller 100b drives the conveyance roller pairs 10 and 11 to start conveying the sheet P on which an image has been formed by the image forming apparatus 2 (step S802). Then, the controller 100b determines whether or not the first liquid application position B1 of the sheet P faces the liquid application unit 140 (more particularly, the liquid application head 146) (step S803). In a case where the controller 100b determines that the first liquid application position B1 of the sheet P does not face the liquid application unit 140 (NO in step S803), the controller 100b continues the conveyance of the sheet P by the conveyance roller pairs 10 and 11 until the first liquid application position B1 of the sheet P faces the liquid application unit 140 (YES in step S803). When the controller 100b determines that the first liquid application position B1 on the sheet P has faced the liquid application head 146 (YES in step S803), the controller 100b causes the conveyance roller pairs 10 and 11 (step S804) to stop conveying the sheet P. It is ascertained, based on a pulse signal output from a rotary encoder of a motor that drives the conveyance roller pairs 10 and 11, that the first liquid application position B1 on the sheet P has faced the liquid application head 146.

The controller 100b causes the liquid application unit 140 to execute the process of applying liquid to the sheet P at the first liquid application position B1 in step S805. More particularly, the controller 100b rotates the application head moving motor 151 in the first direction to bring the liquid application head 146 into contact with the sheet P at the first liquid application position B1. The controller 100b changes the pressing force of the liquid application head 146 (i.e., the amount of rotation or rotation speed of the application head moving motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application head moving motor 151 may be ascertained based on a pulse signal output from a rotary encoder of the application head moving motor 151.

The controller 100b drives the conveyance roller pairs 10, 11, 14, and 15 to stack the sheet P on the internal tray 22 (step S806). In addition, the controller 100b moves the side fences 24L and 24R in the main scanning direction to align the positions of the in the main scanning direction of the sheet P or the sheet bundle Pb stacked on the internal tray 22, that is, execute so-called jogging process (step S806).

The controller 100b determines whether the number of sheets P placed on the internal tray 22 has reached the given number of sheets Np indicated by the post-processing command (step S807). When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

By contrast, when the controller 100b determines that the number of sheets P that are placed on the internal tray 22 has reached the given number of sheets Np (YES in step S807), the controller 100b causes the crimper 32′ to crimp the first binding position B1 (corresponding to the first liquid application position B1) on the sheet bundle Pb to which the liquid has been applied by the liquid application unit 140 (step S808). Further, the controller 100b rotates the conveyance roller pair 15 to eject the crimped and bound sheet bundle Pb to the second ejection tray 26 (step S808).

The controller 100b determines whether the number of copies of the sheet bundle Pb ejected to the second ejection tray 26 has reached the requested number of copies Mp indicated by the post-processing command (step S809). When the controller 100b determines that the number of the sheet bundles Pb ejected to the second ejection tray 26 has not reached the requested number of copies Mp (NO in step S809), the controller 100b repeats the processing of steps S802 to S809 until the number of the sheet bundles Pb ejected to the second ejection tray 26 reaches the requested number of copies Mp (YES in step S809).

When the controller 100b determines that the number of sheet bundles Pb ejected to the second ejection tray 26 reaches the requested number of copies Mp (YES in step S809), the controller 100b drives the liquid applier moving motor 137 to move the liquid application unit 140 to the standby position HP1 (see FIG. 24B) and drives the crimper moving motor 238 to move the crimper 32′ to the standby position HP2 (see FIG. 22A) (step S810). In a case where the posture instructed by the post-processing command is the “inclined binding posture”, the controller 100b drives the application head pivot motor 150 and the crimper pivot motor 239 to rotate the liquid application unit 140 and the crimper 32′ into the parallel binding posture (standby angle) (step S810). On the other hand, when the posture that is instructed by the post-processing command is the “parallel binding posture”, the operation of rotating the liquid application unit 140 and the crimper 32′ to the parallel binding posture (standby angle) is skipped. In steps S801 and S810, the execution order of the movement in the main scanning direction and the rotation in the forward and reverse directions of the liquid application unit 140 and the crimper 32′ is not limited to the aforementioned order and may be reversed.

The embodiments of the present disclosure are applied to the edge binder 25 that executes the edge binding process as described above. However, the embodiments of the present disclosure may be applied to the saddle binder 28 that executes the saddle binding process.

The controller 100b of the post-processing apparatus 3A according to the second embodiment illustrated in FIG. 21 is provided separately from the controller 100a of the image forming apparatus 2 as in the configuration of FIG. 1. However, embodiments of the present disclosure are not limited to the above-described configuration. For example, as illustrated in FIG. 30A, the controller 100b of the post-processing apparatus 3 may be disposed in the image forming apparatus 2. Further, as in the configuration of FIG. 30B, the controller 100b of the post-processing apparatus 3 may be integrated with the controller 100a of the image forming apparatus 2.

As in the configuration of FIG. 31A, the controller 100b of the post-processing apparatus 3A may be divided into a controller 100bl (e.g., a driver system such as a motor) and a controller 100b2 (detector such as a sensor) according to the function, and the controller 100b2 of the post-processing apparatus 3A may be disposed on the side of the image forming apparatus 2. Further, as in the configuration of FIG. 31B, the controller 100b2 of the post-processing apparatus 3A disposed on the side of the image forming apparatus 2 may be integrated with the controller 100a of the image forming apparatus 2.

As described above, the control method by the controller 100b described above is implemented by cooperation between hardware resources of a computer and a program as computer software. In other words, the control method may be a method executed by a computer causing an arithmetic device, a storage device, an input device, an output device, and a control device to operate in cooperation with each other based on a program. In addition, the program may be written in, for example, a storage device or a storage medium and distributed, or may be distributed through, for example, an electric communication line.

The present invention is not limited to each of the above-exemplified embodiments, and various modifications are possible within the range that does not depart from its technical gist, and all the technical contents included in the technical ideas described in the scope of claims are subject to the present invention. Although the above-described embodiments represent preferable examples, various modifications can be achieved by those skilled in the art from the disclosed contents. Such modifications are also included in the technical scope of the present disclosure.

### Aspects of the Present Disclosure

Aspects of the present disclosure are, for example, as follows.

### Aspect 1

In Aspect 1, a medium processing apparatus includes a liquid applier including a liquid application member that comes into contact with a part of at least one medium and applies liquid to the medium, a medium pressing unit that enables the liquid application member to be movable with respect to the medium, a medium pressing position detector that detects a relative position between the medium pressing unit and the liquid application member, and a control unit that determines a movement amount of the liquid application member with respect to the at least one medium based on detection information of the medium pressing position detector, and moves the liquid application member with respect to the medium based on the movement amount.

### Aspect 2

In Aspect 2, in the medium processing apparatus according to Aspect 1, the medium pressing position detector is disposed with a mounting position adjustable with respect to the liquid applier.

### Aspect 3

In Aspect 3, in the medium processing apparatus according to Aspect 1 or 2, the control unit changes the movement amount based on the detection information and the information regarding the medium.

### Aspect 4

In Aspect 4, in the medium processing apparatus according to any one of Aspects 1 to 3, the information regarding the medium includes at least one of thickness information of the medium, basis weight information of the medium, or absorption characteristic information indicating absorbability of the medium in the medium, or category information obtained by dividing each information into categories.

### Aspect 5

In Aspect 5, an image forming system includes an image forming apparatus that forms an image on the medium, and the medium processing apparatus according to any one of

Aspects 1 to 4, the medium processing apparatus performing the liquid application to the medium including a plurality of media on which an image has been formed by the image forming apparatus.

### Aspect 6

In Aspect 6, in the image forming system according to Aspect 5, the image forming apparatus includes the controller.

### Aspect 7

In Aspect 7, a medium processing apparatus includes a liquid applier, a medium pressing unit, a detector, and circuitry. The liquid applier includes a liquid application member to contact a part of a medium and apply liquid to the part of the medium. The medium pressing unit presses the medium to which the liquid is applied, and moves the liquid application member relative to the medium. The detector detects a relative position between the medium pressing unit and the liquid application member. The circuitry is to determine a movement amount of the liquid application member relative to the medium based on the relative position detected by the detector, and move the liquid application member relative to the medium based on the movement amount.

### Aspect 8

In Aspect 8, in the medium processing apparatus of Aspect 7, the detector has a mounting position adjustable relative to the liquid applier.

### Aspect 9

In Aspect 9, in the medium processing apparatus of Aspect 7 or 8, the circuitry is further to change the movement amount of the liquid application member based on the relative position and information regarding the medium.

### Aspect 10

In Aspect 10, in the medium processing apparatus of any one of Aspects 7 to 9, the circuitry is further to acquire information regarding the medium including at least one of: thickness information of the medium; basis weight information of the medium; or absorption characteristic information indicating absorbability of the medium in the medium, or category information obtained by dividing each information into categories.

### Aspect 11

In Aspect 11, an image forming system includes an image forming apparatus to form an image on a medium of each of multiple media, and the medium processing apparatus according to any one of Aspects 7 to 10 to perform liquid application on at least one medium of each of the multiple media on each of which the image has been formed by the image forming apparatus.

### Aspect 12

In Aspect 12, an image forming system includes an image forming apparatus to form an image on each medium of multiple media, and a medium processing apparatus to perform liquid application on at least one medium of the multiple media including each medium on which the image has been formed by the image forming apparatus. The medium processing apparatus includes a liquid applier, a medium pressing unit, and a detector. The liquid applier includes a liquid application member to contact a part of a medium and apply liquid to the part of the medium. The medium pressing unit presses the medium to which the liquid is applied, and moves the liquid application member relative to the medium. The detector detects a relative position between the medium pressing unit and the liquid application member. The image forming apparatus includes circuitry to determine a movement amount of the liquid application member relative to the medium based on the relative position detected by the detector, and move the liquid application member relative to the medium based on the movement amount.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a liquid applier including a liquid application member to contact a part of a medium and apply liquid to the part of the medium;
a medium pressing unit to:
press the medium to which the liquid is applied; and
move the liquid application member relative to the medium;
a medium pressing unit to move the liquid application member relative to the medium;
a detector to detect a relative position between the medium pressing unit and the liquid application member; and
circuitry configured to:
determine a movement amount of the liquid application member relative to the medium based on the relative position detected by the detector; and
move the liquid application member relative to the medium based on the movement amount.

2. The medium processing apparatus according to claim 1,
wherein the detector has a mounting position adjustable relative to the liquid applier.

3. The medium processing apparatus according to claim 1, wherein the circuitry is further configured to change the movement amount of the liquid application member based on the relative position and information regarding the medium.

4. The medium processing apparatus according to claim 1,
wherein the circuitry is further configured to acquire information regarding the medium including at least one of:
thickness information of the medium;
basis weight information of the medium; or
absorption characteristic information indicating absorbability of the medium in the medium, or category information obtained by dividing each information into categories.

5. An image forming system comprising:
an image forming apparatus to form an image on a medium of each of multiple media; and
the medium processing apparatus according to claim 1 to perform liquid application on at least one medium of the medium of each of the multiple media on each of which the image has been formed by the image forming apparatus.

6. An image forming system comprising:
an image forming apparatus to form an image on each medium of multiple media; and
a medium processing apparatus to perform liquid application on at least one medium of the multiple media including each medium on which the image has been formed by the image forming apparatus,
wherein the medium processing apparatus includes:
a liquid applier including a liquid application member to contact a part of a medium and apply liquid to the part of the medium;
a medium pressing unit to:
press the medium to which the liquid is applied; and
move the liquid application member relative to the medium;
a medium pressing unit to move the liquid application member relative to the medium;
a detector to detect a relative position between the medium pressing unit and the liquid application member; and
the image forming apparatus includes circuitry configured to:
determine a movement amount of the liquid application member relative to the medium based on the relative position detected by the detector; and
move the liquid application member relative to the medium based on the movement amount.
